(19) United States
(12) Patent Application Publication
(10) Pub. No.: US 2026/0079653 A1
(43) Pub. Date: Mar. 19, 2026

(54) PRINT SERVER, PRINTER, CONTROL METHOD FOR PRINT SERVER, CONTROL METHOD FOR PRINTER, AND STORAGE MEDIUM

(71) Applicant: CANON KABUSHIKI KAISHA, Tokyo (JP)

(72) Inventor: Ritsuto Sako, Tokyo (JP)

(21) Appl. No.: 19/317,396

(22) Filed: Sep. 3, 2025

(30) Foreign Application Priority Data
Sep. 13, 2024 (JP) 2024-159418

(51) Int. Cl. G06F 3/12

(52) U.S. Cl. CPC G06F 3/1205; G06F 3/121; G06F 3/1234; G06F 3/1255; G06F 3/126; G06F 3/1287

(57) ABSTRACT

A print server manages a logical printer associated with a printing apparatus and a comprehensive logical printer associated with the logical printer, receives a print job with vendor information added from an information processing apparatus and stores the print job in a print queue of the comprehensive logical printer, receives an instruction to move the print job stored in the print queue to the printing apparatus, and in a case where the instruction is received, move the print job to a logical printer associated with the printing apparatus, and when there is an error response for reception of the print job from the printing apparatus, moves the print job to the comprehensive logical printer.

### BACKGROUND

### Field of the Technology

The present disclosure relates to a print server, a printer, a control method for a print server, and a storage medium.

### Description of the Related Art

In a known printing system, printing is executed by the user transmitting a print job directly from a client terminal such as a PC to a printing apparatus. Japanese Patent Laid-Open No. 2020-184230 proposes a cloud print service that uses a cloud service provided on the Internet. In a cloud print service, a client terminal that inputs print jobs and a printer that executing printing are pre-registered in a print server that provides the cloud print service, and the print server functions as a virtual printer.

A virtual printer is a logical printer associated with a print queue and treated as a single virtual printer. An outline of the printing processing in a cloud print service is as follows. The user performs a print job input instruction with respect to a virtual printer from a client terminal. The print job input by the user is stored in the print queue of the virtual printer and is held until the printer receives an instruction from the user. The user logs into a nearby printer and performs a print instruction. The printer receives the print job from a print server and performs printing to execute the printing. Such a printing method is referred to as hold printing as the print job input by the user is held in the print server without being printed. Such a printing method may also be referred to as pull printing as a print job held in the print server is printed via a user instruction.

Also, recently, operating systems (OS) are installed with a print function as standard. Such a print function is referred to as a standard print function. A print support application (PSA) that can be installed in an OS is provided by the vendor of a printing apparatus to provide users with print settings unsupported by the standard print function. The standard print function performs communication with printing apparatuses and print servers using a standard protocol such as the Internet Printing Protocol (IPP). With the IPP, the vendor of the printing apparatus can specify their own vendor extension attributes. Japanese Patent No. 5665582 proposes technology for executing printing according to a vendor extension attribute specified for a print setting unsupported by the standard print function. By adding a vendor extension attribute to the standard print function of the OS, the user can use the print setting specified by the vendor extension attribute. A print setting specified by the vendor extension attribute is referred to as an extended print setting.

Pull printing can be performed by a print job set with the extended print setting for printing being input using a cloud print service and a printing apparatus being designated. When the user designates a printing apparatus that supports the extended print setting and performs pull printing, the printing apparatus can execute printing of the print job according to the extended print setting set by the user.

### SUMMARY

In some cases, a printing apparatus that does not support an extended print setting, such as a printing apparatus of another vendor, may be associated with a virtual printing apparatus of a cloud print service. When a print job including an extended print setting is executed by the printing apparatus that does not support the extended print setting, the print job is executed without the extended print setting set by the user being applied. One aspect of the present disclosure provides technology for using an extended print setting in a cloud print service.

One aspect of the present disclosure provides a print server comprising: one or more memory devices that store a set of instructions; and one or more processors that execute the set of instructions to: manage a logical printer associated with a printing apparatus and a comprehensive logical printer associated with the logical printer, receive a print job with vendor information added from an information processing apparatus and store the print job in a print queue of the comprehensive logical printer, receive an instruction to move the print job stored in the print queue to the printing apparatus, and in a case where the instruction is received, move the print job to a logical printer associated with the printing apparatus, and when there is an error response for reception of the print job from the printing apparatus, move the print job to the comprehensive logical printer.

Another aspect of the present disclosure provides a printer comprising: one or more memory devices that store a set of instructions; and one or more processors that execute the set of instructions to: receive a print job from a print server, obtain vendor information added to the print job, and execute a print job in a case where the vendor information added to the print job and vendor information of a printing apparatus match.

Still another aspect of the present disclosure provides a control method for a print server, comprising: managing a logical printer associated with a printing apparatus and a comprehensive logical printer associated with the logical printer; receiving a print job with vendor information added from an information processing apparatus and storing the print job in a print queue of the comprehensive logical printer; receiving an instruction to move the print job stored in the print queue to the printing apparatus; moving the print job to a logical printer associated with the printing apparatus in a case where the instruction is received; and when there is an error response for reception of the print job from the printing apparatus, moving the print job to the comprehensive logical printer.

Yet still another aspect of the present disclosure provides a non-transitory computer-readable storage medium storing a program that causes a print server to execute a control method when executed by a computer of the print server, the method comprising: managing a logical printer associated with a printing apparatus and a comprehensive logical printer associated with the logical printer; receiving a print job with vendor information added from an information processing apparatus and storing the print job in a print queue of the comprehensive logical printer; receiving an instruction to move the print job stored in the print queue to the printing apparatus; moving the print job to a logical printer associated with the printing apparatus in a case where the instruction is received; and when there is an error response for reception of the print job from the printing apparatus, moving the print job to the comprehensive logical printer.

Still yet another aspect of the present disclosure provides a control method for a printer, comprising: receiving a print job from a print server; obtaining vendor information added to the print job; and executing a print job in a case where the vendor information added to the print job and vendor information of a printing apparatus match.

Yet still another aspect of the present disclosure provides a non-transitory computer-readable storage medium storing a program that causes a printer to execute a control method when executed by a computer of the printer, the method comprising: receiving a print job from a print server; obtaining vendor information added to the print job; and executing a print job in a case where the vendor information added to the print job and vendor information of a printing apparatus match.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic view for describing a configuration example according to an embodiment.

FIG. 2 is a block diagram for describing an example of the hardware configuration of a computer according to an embodiment.

FIG. 3 is a block diagram for describing an example of the functional configuration of a print server according to an embodiment.

FIG. 4 is a block diagram for describing an example of the functional configuration of an information processing apparatus according to an embodiment.

FIG. 5 is a block diagram for describing an example of the hardware configuration of a printing apparatus according to an embodiment.

FIG. 6 is a schematic view for describing an example of the configuration of an operation unit of a printing apparatus according to an embodiment.

FIG. 7 is a block diagram for describing an example of the functional configuration of a printing apparatus according to an embodiment.

FIG. 8 is a sequence diagram for describing the overall processing of cloud printing according to an embodiment.

FIG. 9 is a network diagram illustrating an example of the configuration of a printing system according to an embodiment.

FIG. 10 is a flowchart for describing installation of a PSA according to an embodiment.

FIG. 11 is a diagram for describing a standard print settings screen according to an embodiment.

FIG. 12 is a diagram for describing a print settings screen by a PSA according to an embodiment.

FIG. 13 is a diagram for describing a standard print setting and an extended print setting from a vendor according to an embodiment.

FIG. 14 is a diagram for describing an extended print settings screen according to an embodiment.

FIG. 15 is a network diagram illustrating an example of the configuration of a printing system including printers of a plurality of vendors according to an embodiment.

FIG. 16 is a diagram for describing a warning display screen according to an embodiment.

FIG. 17 is a flowchart for adding vendor information to a print job according to an embodiment.

FIG. 18 is a flowchart for describing printing processing using vendor information according to an embodiment.

FIG. 19 is a flowchart for describing processing by a print server using vendor information according to an embodiment.

FIG. 20 is a diagram for describing a cloud printing sequence according to an embodiment

FIG. 21 is a flowchart for describing processing by a printing apparatus using vendor information according to an embodiment.

FIG. 22 is a diagram for describing a display screen of a printing apparatus according to an embodiment.

FIG. 23 is a diagram for describing a cloud printing sequence according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Printing System Configuration Example

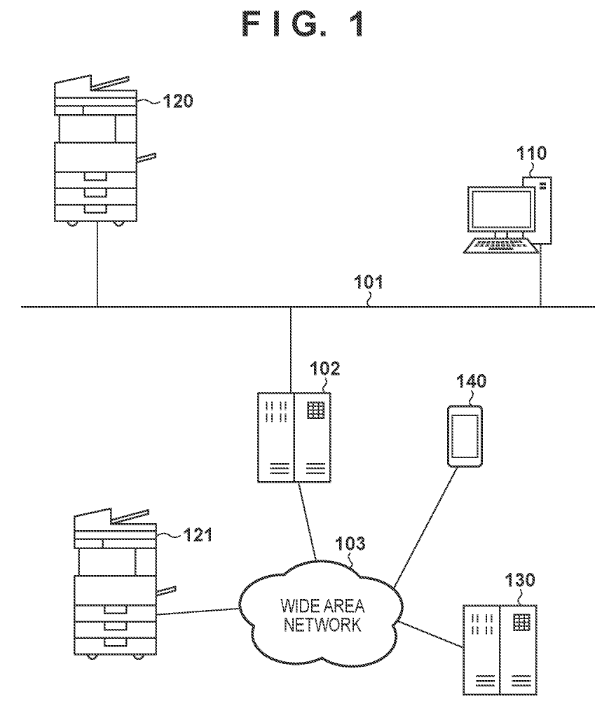

An example of the configuration of a printing system according to an embodiment will now be described with reference to FIG. 1. The printing system, for example, includes an information processing apparatus 110, printing apparatuses 120 and 121, a print server 130, and a portable communication apparatus 140. The number of the component elements of the printing system is not limited to the number in the example of FIG. 1. Also, the printing system may include component elements not illustrated in FIG. 1.

The information processing apparatus 110 and the printing apparatus 120 are connected to an identical local area network (LAN) 101. The LAN 101 may be a wired LAN, a wireless LAN, or a combination thereof. The LAN 101 is connected to a wide area network 103 (for example, the Internet) via a firewall 102. The printing apparatus 121 and the print server 130 are also connected to the wide area network 103. The information processing apparatus 110 and the printing apparatus 120 can communicate with one another in the LAN 101 (in other words, without using the wide area network 103). Also, each of the information processing apparatus 110 and the printing apparatus 120 can communicate with the print server 130 via the LAN 101, the firewall 102, and the wide area network 103. The printing apparatus 121 may be connected to the wide area network 103 via a LAN or cellular network (for example, a network compliant with a fourth generation communication standard (4G) or a fifth generation communication standard (5G)). The information processing apparatus 110 and the portable communication apparatus 140 may also be connected to the wide area network 103 via a cellular network. Also, the portable communication apparatus 140 may also be able to connect to the LAN 101.

The printing apparatuses 120 and 121 include a print function for printing according to a print job. The printing apparatuses 120 and 121 may include at least one of a scanner function and a fax function in addition to the print function. Such a printing apparatus with a plurality of functions may be referred to as a multifunction peripheral (MFP). In another example, the printing apparatuses 120 and 121 may be a single function peripheral (SFP) with only the print function. Printing may refer to printing on a sheet-like printing medium such as paper or the forming of three-dimensional objects (so-called 3D printing).

The print server 130 provides a printing service that transmits a print job to any one of one or more printing apparatuses (for example, the printing apparatus 120) registered in the print server 130 according to the print job generated by the information processing apparatus 110. For example, the print server 130 provides a logical printer to the information processing apparatus 110 and receives a print job for the logical printer. A logical printer is a virtual printing apparatus (for example, a printer object) provided by the print server 130. A logical printer may be referred to as a cloud printer. As with the printing apparatuses 120 and 121, the information processing apparatus 110 can generate a print queue for the logical printer. In contrast to the logical printer, a physical printing apparatus such as the printing apparatuses 120 and 121 may be referred to as a physical printer. Hereinafter, logical printers and physical printers are collectively referred to as simply printers. A physical printer may be referred to as a local printer in a case where it is connected to the same LAN as the information processing apparatus that is input with the print job.

The print server 130 may be a server in an on-premises environment connected to the Internet 103 or may be a server in a cloud computing environment (referred to below simply as the cloud). A printing service provided by the print server 130 in the cloud may be referred to as a cloud print service. An example of a cloud print service includes Universal Print (registered trademark) provided by Microsoft Corporation. In the examples described below, the print server 130 is in the cloud. However, the following description also applies in a similar manner to an example in which the print server 130 is in an on-premises environment.

The information processing apparatus 110 provides a print function to the user of the information processing apparatus 110. The information processing apparatus 110 may be a personal computer (PC), may be a smartphone, or may be another device. The information processing apparatus 110 may designate a physical printer (for example, the printing apparatus 120) connected to the same LAN 101 as the output destination of the printed material. Printing performed when a print job is directly (in other words, via the LAN) input to the physical printer may be referred to as local printing.

The information processing apparatus 110 may designate the logical printer provided by the print server 130 as the output destination of the printed material. In a case where the logical printer is designated as the output destination, the physical printer (for example, the printing apparatus 120) associated with the logical printer performs the printing. The information processing apparatus 110 that uses the cloud print service may be referred to as a client or a client terminal. The printing performed when a print job is input to the logical printer may be referred to as cloud printing or remote printing. The printing performed when a print job is input to the logical printer may be executed by the printing apparatus 120 connected to the same LAN 101 as the information processing apparatus 110 or may be executed by the printing apparatus 121 not connected to the LAN 101. Of the printing apparatuses 120 and 121, the printing apparatus 120 is described in the following example, but the description also applies to the printing apparatus 121. The printing apparatus is not limited to the printing apparatus 120 connected to the same LAN as the information processing apparatus 110 and may be the printing apparatus 121 not connected to the LAN.

In the example of FIG. 1, the information processing apparatus 110 can execute both local printing and remote printing. In another example, the information processing apparatus 110 may be able to execute only remote printing.

The information processing apparatus 110 may include a print function included as standard in the operating system (OS). Such a print function is referred to as a standard print function. The standard print function may also be referred to as an OS standard print function or a native print function. The information processing apparatus 110 with the standard print function does not need separate software (for example, a driver) to use a printing apparatus that supports the standard print function. Examples of standard print functions include AirPrint (registered trademark) included as standard in iOS (registered trademark), macOS (registered trademark), and the like and Mopria (registered trademark) included as standard in Windows (registered trademark), Android (registered trademark), and the like.

### Example of Hardware Configuration of Computer

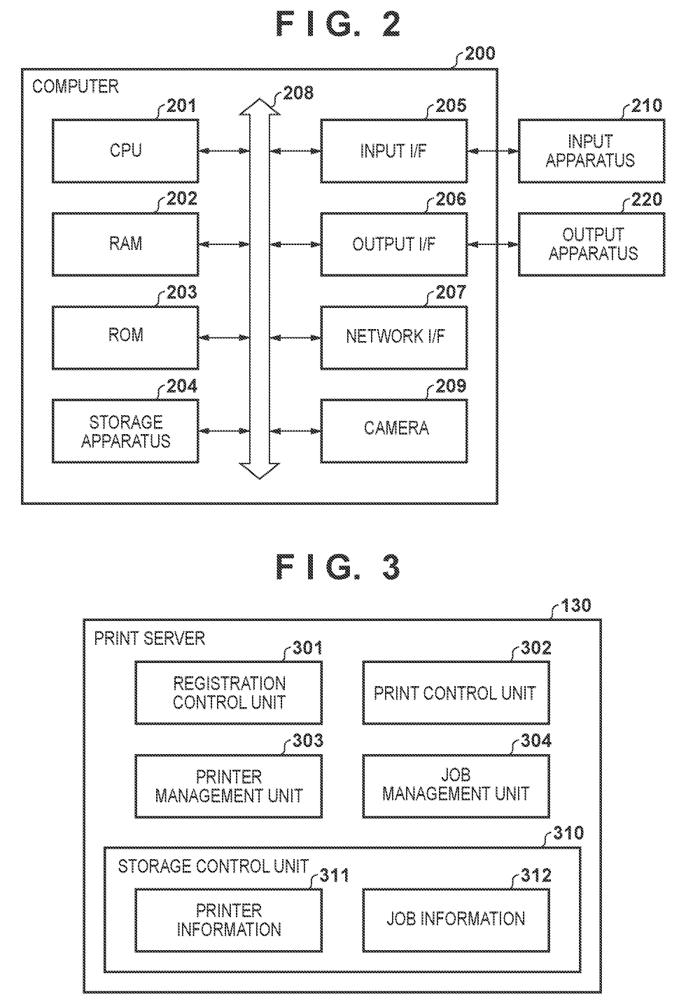

An example of the hardware configuration of a computer 200 according to an embodiment will be described with reference to FIG. 2. The computer 200 may be used as the information processing apparatus 110, may be used as the print server 130, and may be used as the portable communication apparatus 140. The computer 200 may include the component elements illustrated in FIG. 2, may not include one or more of the component elements illustrated in FIG. 2, and may include a component element not illustrated in FIG. 2.

A central processing unit (CPU) 201 is general-purpose processing circuitry that controls the entire operations of the computer 200. A random-access memory (RAM) 202 is volatile memory circuitry used as a temporary storage area such as a working area for processing by the CPU 201. A read-only memory (ROM) 203 is non-volatile memory circuitry that stores programs and data used in the processing by the CPU 201. A storage apparatus 204 is a non-volatile storage apparatus that stores programs and data used in the processing by the CPU 201. The storage apparatus 204 may be a hard disk drive (HDD) or a solid state drive (SSD), for example. The storage apparatus 204 may be referred to as a secondary storage apparatus. The operations by the computer 200 may be implemented by the CPU 201 executing a program read out from the storage apparatus 204 onto the RAM 202.

An input interface (I/F) 205 is an I/F for exchanging signals with an input apparatus 210. The input apparatus 210 is an apparatus that obtains input from the user of the computer 200. The input apparatus 210 may be a keyboard, a touch panel, a microphone, a mouse, or any combination thereof, for example. An output I/F 206 is an I/F for exchanging signals with an output apparatus 220. The output apparatus 220 is an apparatus that provides information to the user of the computer 200. The output apparatus 220 may be a display, a speaker, or any combination thereof, for example. A network I/F 207 is an I/F for communicating with an apparatus external to the computer 200. Each of the CPU 201, the RAM 202, the ROM 203, the storage apparatus 204, the input I/F 205, the output I/F 206, and the network I/F 207 are connected to a system bus 208. In the example of FIG. 2, the input apparatus 210 and the output apparatus 220 are illustrated as separate apparatuses to the computer 200. In another example, the computer 200 may include the input apparatus 210 and the output apparatus 220. For example, in a case where the computer 200 is used as the portable communication apparatus 140, the portable communication apparatus 140 may include the input apparatus 210 and the output apparatus 220. Also, the computer 200 (in particular, the portable communication apparatus 140) may include a camera 209.

### Example of Functional Configuration of Print Server

An example of the functional configuration of the print server 130 will now be described with reference to FIG. 3. The print server 130 may include the component elements illustrated in FIG. 3, may not include one or more of the component elements illustrated in FIG. 3, and may include a component element not illustrated in FIG. 3. Each component element of FIG. 3 may be implemented by the CPU 201 executing a program read out to the RAM 202. In another example, one or more or all of the component elements of FIG. 3 may be implemented by dedicated processing circuitry such as an application specific integrated circuit (ASIC) or the like.

A registration control unit 301 executes processing for registering a logical printer. For example, in response to a start registration request from the printing apparatus 120, the registration control unit 301 generates a logical printer associated with a physical printer and registers printer information 311. The logical printer registered in the printer information 311 is recognized as a printer by the information processing apparatus 110. The physical printer associated with the logical printer may be a physical printer that performing printing according to a print job input for the logical printer. The logical printer may be associated with only one physical printer. The physical printer may be associated with only one logical printer or may be associated with a plurality of logical printers.

A print control unit 302 executes processing related to a print job for the logical printer. For example, the print control unit 302 receives a print job for the logical printer from the information processing apparatus 110 and, on the basis of this, transmits the print job to the physical printer associated with the logical printer. Also, the print control unit 302 may control events related to print jobs. An event related to a print job may include receiving a print job and the like, for example. The print control unit 302 may respond with an event related to the physical printer in response to receiving an event request from the physical printer.

A printer management unit 303 manages the information related to the logical printer registered in the print server 130 as the printer information 311. The printer information 311 includes the names of physical printers associated with logical printers, capability information, cloud printer IDs uniquely allocated to logical printers, information of a print queue for spooling print jobs, and the like.

A job management unit 304 manages the information related to the print job received from the information processing apparatus 110 as job information 312. The job information 312 includes the print job information and state, print data designated by the print job, and the like.

A storage control unit 310 stores information in the RAM 202 and the storage apparatus 204 and reads out information from the RAM 202 and the storage apparatus 204 according to instructions from other component elements. According to an embodiment, the storage control unit 310 stores the printer information 311 and the job information 312.

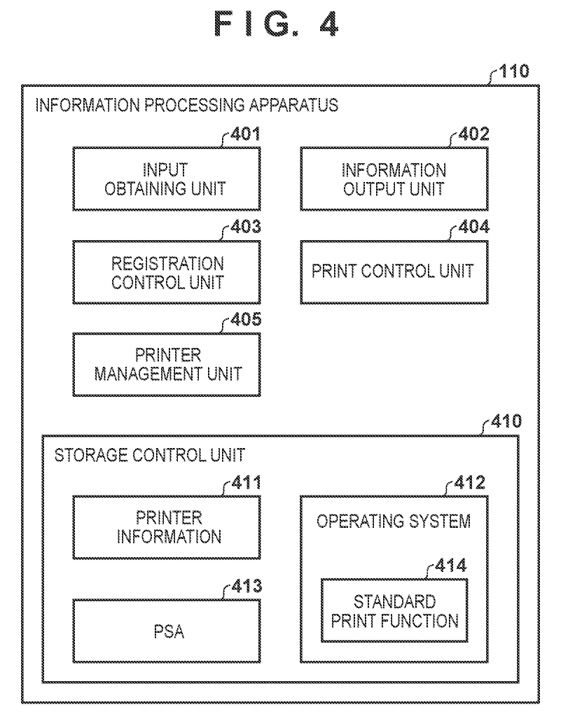

Example of Functional Configuration of Information Processing Apparatus An example of the functional configuration of the information processing apparatus 110 will now be described with reference to FIG. 4. The information processing apparatus 110 may include the component elements illustrated in FIG. 4, may not include one or more of the component elements illustrated in FIG. 4, and may include a component element not illustrated in FIG. 4. Each component element of FIG. 4 may be implemented by the CPU 201 executing a program read out to the RAM 202. In another example, one or more or all of the component elements of FIG. 4 may be implemented by dedicated processing circuitry such as an ASIC or the like.

An input obtaining unit 401 obtains input from the user of the information processing apparatus 110 using the input I/F 205. An information output unit 402 outputs information to the user of the information processing apparatus 110 using the output I/F 206.

A registration control unit 403 executes processing for registering the logical printer in the print server 130. A print control unit 404 executes processing related to printing by a printer. The print control unit 404 generates a print job from print data and print setting. For example, the print control unit 404 may transmit a print job to a logical printer registered in the print server 130 according to a printing instruction from the user of the information processing apparatus 110. The print control unit 404 may directly (in other words, in the same LAN) transmit a print job to a physical printer according to a printing instruction from the user of the information processing apparatus 110.

A printer management unit 405 manages information related to printers which can be input with a print job by the information processing apparatus 110 as printer information 411. The printer information 411 includes the names of printers, capability information, and the like. The printer management unit 405 may search for a printer which can be input with a print job by the information processing apparatus 110.

A storage control unit 410 stores information in the RAM 202 and the storage apparatus 204 and reads out information from the RAM 202 and the storage apparatus 204 according to instructions from other component elements. According to an embodiment, the storage control unit 410 stores the printer information 411 and an operating system (OS) 412. The OS 412 is installed as standard in the information processing apparatus 110 (in other words, at the time of shipping the information processing apparatus 110). The OS 412 may be updated. The OS 412 includes a function for basic management and control of the information processing apparatus 110. The OS 412 includes a standard print function 414.

The storage control unit 410 may further store a print support application (PSA) 413. The PSA 413 is an application (plugin) installed in the OS 412 for extending the standard print function 414. The PSA 413 is provided by the vendor of the printing apparatus 120. The PSA 413 enables a print setting not supported by the standard print function 414 to be used by the user of the information processing apparatus 110.

The standard print function 414 may support a standard protocol. Supporting a protocol may mean interpreting a command compliant with the protocol and operating according to the command. The standard protocol supported by the standard print function 414 may be a protocol standardized by a standards body (standardized) or may be a protocol which is a de facto standard. In the example described below, the standard protocol supported by the standard print function 414 is the Internet Printing Protocol (IPP). The following description related to the IPP also applies to other standard protocols.

The PSA 413 may support a protocol other than the standard protocol supported by the standard print function 414. The standard print function 414 may not support the protocol supported by the PSA 413. The protocol supported by the PSA 413 may be a standard protocol other than the standard protocol supported by the standard print function 414. For example, the protocol supported by the PSA 413 may be a vendor-specific protocol of the printing apparatus 120. An example in which the protocol supported by the PSA 413 is common peripheral controlling architecture (CPCA) will be described below. The CPCA is a vendor-specific protocol of the printing apparatus 120. The following description related to the CPCA also applies to protocols other than the standard protocol supported by the standard print function 414.

### Example of Hardware Configuration of Printing Apparatus

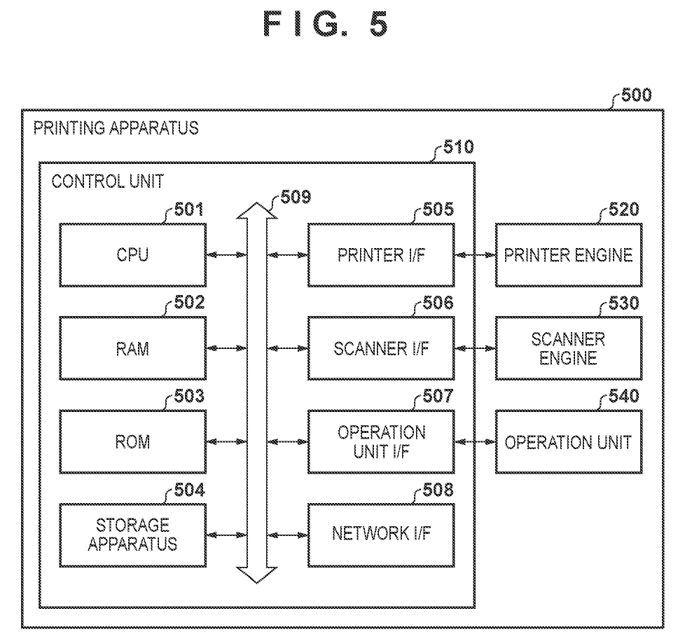

An example of the hardware configuration of a printing apparatus 500 according to an embodiment will now be described with reference to FIG. 5. The printing apparatus 500 may be used as the printing apparatus 120 or may be used as the printing apparatus 121. The printing apparatus 500 may include the component elements illustrated in FIG. 5, may not include one or more of the component elements illustrated in FIG. 5, and may include a component element not illustrated in FIG. 5. The printing apparatus 500 is a physical printing apparatus and thus may be referred to as a physical printer.

A CPU 501 is general-purpose processing circuitry that controls the entire operations of the printing apparatus 500. A RAM 502 is volatile memory circuitry used as a temporary storage area such as a working area for processing by the CPU 501. A ROM 503 is non-volatile memory circuitry that stores programs and data used in the processing by the CPU 501. A storage apparatus 504 is a non-volatile storage apparatus that stores programs and data (for example, print jobs, image data, and settings information) used in processing by the CPU 501. The storage apparatus 504 may be a HDD or an SSD, for example. The storage apparatus 504 may be referred to as a secondary storage apparatus. The operations by the printing apparatus 500 may be implemented by the CPU 501 executing a program read out from the storage apparatus 504 onto the RAM 502.

A printer I/F 505 is an I/F for exchanging signals with a printer engine 520. The printer engine 520 performs printing on the basis of a signal (for example, an image signal or a print command) supplied from a control unit 510 via the printer I/F 505. The printing may be electro-photographic printing in which toner is transferred and fixed onto paper, inkjet printing in which printing is performed by ink being discharged onto paper, or three-dimensional printing.

A scanner I/F 506 is an I/F for exchanging signals with a scanner engine 530. The scanner engine 530 supplies a signal (for example, an image signal) obtained by a document being scanned to the control unit 510 via the scanner I/F 506. The CPU 501 may process the image signal supplied from the scanner engine 530 and supply the signal for image printing obtained in this manner to the printer engine 520. Also, the CPU 501 may generate image data on the basis of the image signal supplied from the scanner engine 530 and transmit the image data to an external apparatus.

An operation unit I/F 507 is an I/F for exchanging signals with an operation unit 540. The operation unit 540 is an apparatus that obtains an input from the user of the printing apparatus 500 and provides information to the user of the printing apparatus 500. The operation unit 540 may be constituted of a display panel (for example, a liquid crystal display), a speaker, a touch panel, a keyboard, a button, a touch screen, or any combination thereof, for example.

A network I/F 508 is an I/F for communicating with an apparatus external to the printing apparatus 500. The control unit 510 is constituted of the CPU 501, the RAM 502, the ROM 503, the storage apparatus 504, the printer I/F 505, the scanner I/F 506, the operation unit I/F 507, and the network I/F 508. Each component element included in the control unit 510 is connected to a system bus 509.

### Example of Configuration of Operation Unit of Printing Apparatus

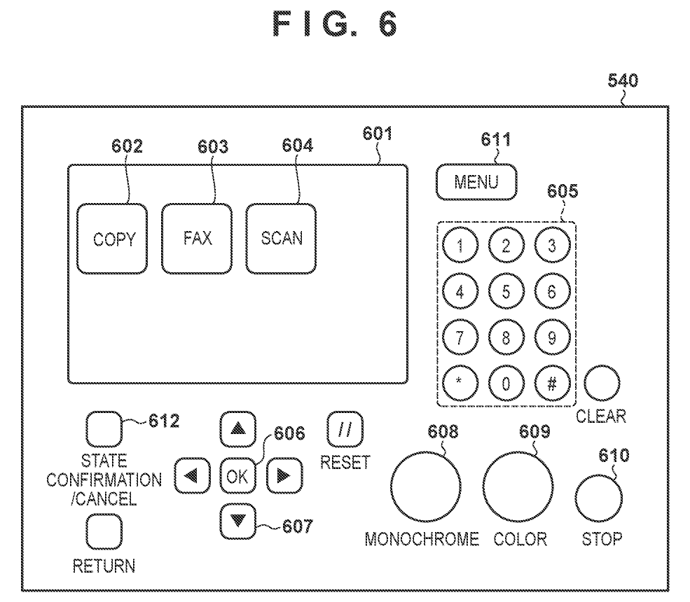

An example of the configuration of the operation unit 540 of the printing apparatus 500 will now be described with reference to FIG. 6. In the example of FIG. 6, the operation unit 540 is configured as a control panel formed in a panel-like shape. The operation unit 540 may include the component elements illustrated in FIG. 6. The operation unit 540 may include a component element not illustrated in FIG. 6.

A display panel 601 is a touch screen including an integrally formed touch panel for obtaining input from the user and display (for example, a liquid crystal display) for displaying information to the user. In the example of FIG. 6, the display panel 601 displays buttons 602 to 604. The button 602 is a software button for obtaining an instruction to transition to copy mode from the user. In response to the user touching the button 602, the printing apparatus 500 displays a copy operation screen on the display panel 601. The button 603 is a software button for obtaining an instruction to transition to FAX mode from the user. In response to the user touching the button 603, the printing apparatus 500 displays a FAX operation screen on the display panel 601. The button 604 is a software button for obtaining an instruction to transition to scanner mode from the user. In response to the user touching the button 604, the printing apparatus 500 displays a scanner operation screen on the display panel 601. In addition, a dialog for performing an exchange with the user and a cloud printing job list may be displayed on the display panel 601.

A tenkey 605 is a set of physical buttons for obtaining an input of numbers and the like from the user. A button 606 is a physical button for obtaining an instruction for determining the display content of the display panel 601 and the like from the user. A directional key 607 is a physical button for obtaining an instruction for selecting an item from a menu displayed on the display panel 601 and the like from the user. A button 608 is a physical button for obtaining an instruction for monochrome copying from the user. A button 609 is a physical button for obtaining an instruction for color copying from the user. A button 610 is a physical button for obtaining an instruction for stopping processing from the user. A button 611 is a physical button for obtaining an instruction for displaying the menu screen for setting the settings of the printing apparatus 500 and the like from the user. A button 612 is a physical button for obtaining an instruction for displaying the status of the printing apparatus 500, such as a list of the print jobs received by the printing apparatus 500 and the like, from the user.

### Example of Functional Configuration of Printing Apparatus

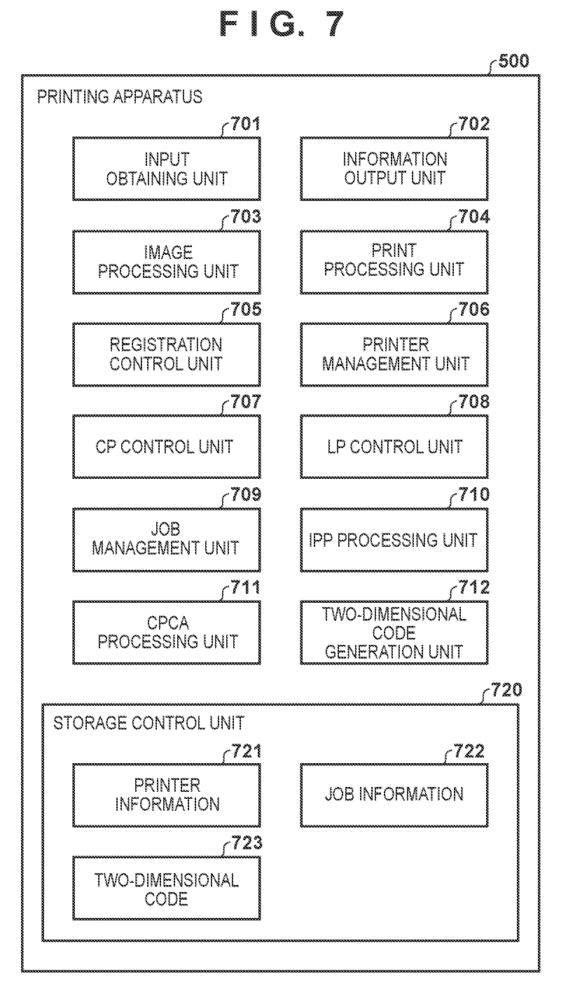

An example of the functional configuration of the printing apparatus 500 will now be described with reference to FIG. 7. The printing apparatus 500 may include the component elements illustrated in FIG. 7, may not include one or more of the component elements illustrated in FIG. 7, and may include a component element not illustrated in FIG. 7. Each component element of FIG. 7 may be implemented by the CPU 501 executing a program read out to the RAM 502. In another example, one or more or all of the component elements of FIG. 7 may be implemented by dedicated processing circuitry such as an ASIC or the like.

An input obtaining unit 701 obtains an input from the user of the printing apparatus 500 using the operation unit I/F 507. An information output unit 702 outputs information to the user of the printing apparatus 500 using the operation unit I/F 507. For example, the information output unit 702 displays an operation menu on the operation unit 540. The input obtaining unit 701 obtains an input on the operation menu and notifies the other component elements of the input instruction content. The information output unit 702 displays the result obtained from the other component elements on the operation unit 540.

An image processing unit 703 performs rendering of the print job into image data for printing. A print processing unit 704 prints the image data rendered by the image processing unit 703.

A registration control unit 705 executes processing for registering a logical printer associated with the printing apparatus 500 in the print server 130. A printer management unit 706 manages the information related to the printing apparatus 500 as printer information 721. The printer information 721, for example, may include the name of the printing apparatus 500, the state of the printing apparatus 500, the capability information of the printing apparatus 500, and the cloud printer ID uniquely allocated by the print server 130 to the logical printer associated with the printing apparatus 500. Also, the printer information 721 may include a local printer ID for the information processing apparatus 110 to identify the printing apparatus in the same LAN 101. The capability information of the printing apparatus 500 is information related to the capability of the printing apparatus 500 and may include the printing apparatus 500 including a specific function, for example.

A cloud printing (CP) control unit 707 executes processing related to cloud printing. For example, the CP control unit 707 may transfer print data included in a print job received from the print server 130 to the image processing unit 703 to perform printing according to the print job transmitted from the print server 130. Also, the CP control unit 707 may transmit an event request to the print server 130.

A local printing (LP) control unit 708 executes processing related to local printing. For example, the LP control unit 708 may respond to a printer search from the information processing apparatus 110. Also, the LP control unit 708 may transfer print data included in a print job directly received from the information processing apparatus 110 to the image processing unit 703 to perform printing according to the print job transmitted from the information processing apparatus 110. A job management unit 709 manages the information related to the print jobs as job information 722. The job information 722 may include the processing state and processing result of a print job.

An IPP processing unit 710 executes processing related to the IPP. For example, the IPP processing unit 710 receives a message compliant with the IPP from an external apparatus (the information processing apparatus 110 or the print server 130), interprets the message, and executes the processing designated by the message. The IPP processing unit 710 may include a server function. For example, the IPP processing unit 710 may be allocated with a specific port number, and the message designating the port number may be passed to the IPP processing unit 710.

A CPCA processing unit 711 executes processing related to the CPCA. For example, the CPCA processing unit 711 receives a message compliant with the CPCA from an external apparatus (the information processing apparatus 110 or the print server 130), interprets the message, and executes the processing designated by the message. The CPCA processing unit 711 may include a server function. For example, the CPCA processing unit 711 may be allocated with a specific port number, and the message designating the port number may be passed to the CPCA processing unit 711. The message for the CPCA processing unit 711 may passed from another component element (for example, the IPP processing unit 710) of the printing apparatus 500 via local loopback. Also, the CPCA processing unit 711 may provide an application programming interface (API) and may obtain an instruction from another component element (for example, the IPP processing unit 710) via the API.

A two-dimensional code generation unit 712 generates a two-dimensional code for encoded information (for example, a cloud printer ID corresponding to a physical printer). The two-dimensional code may be a QR code (registered trademark) or may be another two-dimensional code.

A storage control unit 720 stores information in the RAM 502 and the storage apparatus 504 and reads out information from the RAM 502 and the storage apparatus 504 according to instructions from other component elements. According to an embodiment, the storage control unit 720 stores the printer information 621, the job information 722, and a two-dimensional code 722. The two-dimensional code 722 is a two-dimensional code for an encoded cloud printer ID allocated to a logical printer associated with the printing apparatus 500. The storage control unit 720 may manage data as a file system. The storage control unit 720 may divide the storage destination of each piece of data between the storage apparatus 504, the non-volatile area, and the RAM 502, the volatile area. For example, the storage control unit 720 may store the printer information 721 and the job information 722 in a non-volatile area.

### Overall Processing Sequence for Cloud Printing

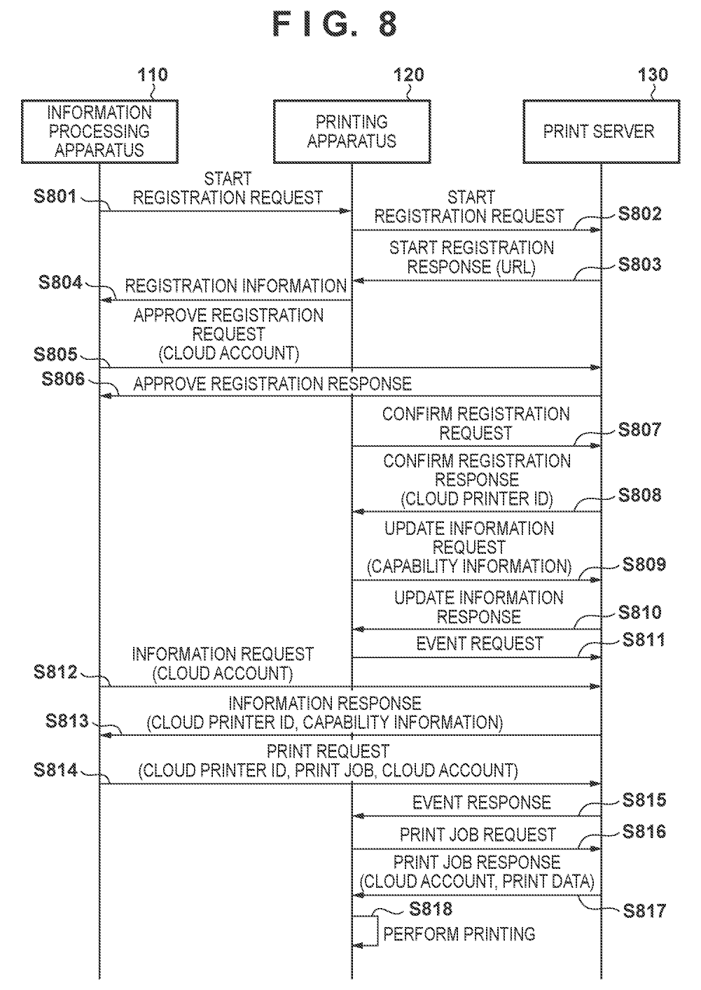

The overall processing sequence for performing cloud printing will now be described with reference to FIG. 8. In the example of FIG. 8, the information processing apparatus 110 registers the printing apparatus 120 in the print server 130 and a print job is input to the logical printer associated with the printing apparatus 120. The printing apparatus 120 being registered in the print server 130 may include the logical printer associated with the printing apparatus 120 being registered in the print server 130. In the following example, the printing apparatus 120 supports a web user interface (UI) function for operating the printing apparatus 120 from the information processing apparatus 110. Also, the information processing apparatus 110 supports a web UI client function. The communication between the information processing apparatus 110, the printing apparatus 120, and the print server 130 may be performed using the Internet Printing Protocol (IPP).

In S801, the registration control unit 403 of the information processing apparatus 110 transmits start registration request to the printing apparatus 120 according to an instruction from the user of the information processing apparatus 110. The start registration request may be a request to start the processing for registering the printing apparatus 120 in the print server 130. The start registration request may be transmitted using the web UI client function of the information processing apparatus 110.

In S802, the registration control unit 705 of the printing apparatus 120 transmits the start registration request to the print server 130 in response to receiving the start registration request from the information processing apparatus 110. The start registration request may be a request to start the processing for registering the printing apparatus 120 in the print server 130.

In S803, the registration control unit 301 of the print server 130 transmits the start registration request to the printing apparatus 120 in response to receiving the start registration request from the printing apparatus 120. The start registration response includes the uniform resource locator (URL) of the webpage for the user of the information processing apparatus 110 to input information for registering the printing apparatus 120 in the print server 130.

In S804, the registration control unit 705 of the printing apparatus 120 transmits the registration information to the information processing apparatus 110 in response to receiving the start registration response from the print server 130. The registration information includes the URL included in the start registration response. The information output unit 402 of the information processing apparatus 110 displays the webpage to the user in response to receiving the registration information from the printing apparatus 120.

In S805, the registration control unit 403 of the information processing apparatus 110 transmits an approve registration request to the print server 130 in response to the user of the information processing apparatus 110 accessing the URL and inputting the information required for registration. The approve registration request includes the cloud account of the user of the information processing apparatus 110. A cloud account is an account for a user to use a tenant of the cloud including the print server 130.

In S806, the registration control unit 301 of the print server 130 checks whether or not the cloud account included in the approve registration request is that of a user with permission to register the printing apparatus 120 in the print server 130. In a case where the user has permission, the registration control unit 301 of the print server 130 transmits an approve registration response to the information processing apparatus 110. The approve registration response may be a message notifying the user of the information processing apparatus 110 that the user has permission to register the printing apparatus 500.

In S807, the printer management unit 706 of the printing apparatus 120 transmits a confirm registration request to the print server 130 in response to receiving the start registration response from the print server 130. The confirm registration request may be a request related to registering the printing apparatus 120 in the print server 130, and specifically may be a request to register the printing apparatus 500 in the print server 130.

In S808, the printer management unit 303 of the print server 130, in response to receiving the confirm registration request from the printing apparatus 500, generates a new logical printer and adds the logical printer to the printer information 311 in association with the printing apparatus 120. Accordingly, the printing apparatus 120 is registered in the print server 130, and the information processing apparatus 110 becomes able to perform cloud printing using the logical printer. Also, the printer management unit 303 of the print server 130 allocates a unique cloud printer ID to the generated logical printer and adds the cloud printer ID to the printer information 311 in association with the logical printer. Thereafter, the registration control unit 301 of the print server 130 transmits a confirm registration response to the printing apparatus 120. The confirm registration response includes the cloud printer ID of the printing apparatus 120.

In S809, the printer management unit 706 of the printing apparatus 120 transmits an update information request to the print server 130 in response to completion of the registration of the printing apparatus 120 in the print server 130. The update information request may be a request to update the information related to the printing apparatus 120. The update information request includes the capability information of the printing apparatus 120. The update information request may be transmitted via an Update-Output-Device-Attributes request message specified by the IPP.

In S810, the printer management unit 303 of the print server 130, on the basis of the capability information included in the received update information request, updates the information of the printing apparatus 120 included in the printer information 311 and transmits an update information response to the printing apparatus 500. The update information response may be a message for notifying of the successful completion of the update of the information of the printing apparatus 120.

In S811, the CP control unit 707 of the printing apparatus 120 transmits an event request to the print server 130 in response to receiving the confirm registration response from the print server 130. The event request may be a request to notify the printing apparatus 120 in a case where an event related to the printing apparatus 120 has occurred. The event request may be related to an event in which a print job has been input to the logical printer associated with the printing apparatus 120.

In S812, the printer management unit 405 of the information processing apparatus 110 transmits an information request to the print server 130 according to an instruction from the user of the information processing apparatus 110. The information request may be a request for obtaining information related to the logical printer that can be used by the user of the information processing apparatus 110. The information request includes the cloud account of the user of the information processing apparatus 110. The information request may be transmitted via a Get-Printer-Attributes Request message specified by the IPP.

In S813, the printer management unit 303 of the print server 130 transmits an information response to the information processing apparatus 110 in response to receiving the information request from the information processing apparatus 110. The information response includes the cloud printer ID and capability information for each of the one or more logical printers that the user of the information processing apparatus 110 can use. The printer management unit 405 of the information processing apparatus 110 updates the printer information 411 on the basis of the information response. In this manner, the found logical printer is registered in the standard print function 414 of the information processing apparatus 110. The information response may be transmitted via a Get-Printer-Attributes Response message specified by the IPP.

In S814, the printer management unit 405 of the information processing apparatus 110 transmits a print request to the print server 130 according to an instruction from the user of the information processing apparatus 110. The print request includes the cloud printer ID, the print job, and the cloud account of the user of the information processing apparatus 110. The print job may include print data and print settings. The print request may be a request for the logical printer including the cloud printer ID included in the print request to print the print data included in the print request. The information processing apparatus 110 may instruct the logical printer registered in the standard print function 414 to print.

In S815, the print control unit 302 of the print server 130 transmits an event response to the printing apparatus 500 associated with the logical printer in response to receiving the print request from the information processing apparatus 110. The event response is a response to the event request received in S711. The event response is a response for notifying of the occurrence of the type of event designated by the event request.

In S816, the CP control unit 707 of the printing apparatus 120 transmits a print job request to the print server 130 in response to receiving an event response from the print server 130. The print job request may be a request for obtaining the print job to be executed by the printing apparatus 120.

In S817, the print control unit 302 of the print server 130 transmits a print job response to the printing apparatus 120 in response to receiving the print job request from the printing apparatus 120. The print job response includes the cloud account and the print job. The print job response received by the printing apparatus 120 from the print server 130 may be an IPP Fetch-Job Response message. In S818, the printing apparatus 500 performs printing according to the print job in response to receiving the print job response from the print server 130.

In the description of FIG. 8, registration of the printing apparatus 120 in steps S801 to S806 and cloud printing in steps S812 and S818 may be performed by the same user or by different users.

### Comprehensive Logical Printer and Individual Logical Printer

A comprehensive logical printer and an individual logical printer provided by the print server 130 will now be described. In the present embodiment, the print server 130 may be able to provide a comprehensive logical printer and an individual logical printer. As described above, a logical printer is a virtual printing apparatus (for example, a printer object) provided by the print server 130. An individual logical printer is a logical printer associated with a specific physical printer. A print job input to an individual logical printer can be printed by the physical printer associated with the individual logical printer. A comprehensive logical printer is a physical printer that is not directly associated with a specific physical printer and is associated with one or more individual logical printers. Typically, a comprehensive logical printer is associated with a plurality of individual logical printers. A print job input to a comprehensive logical printer moves to one of the individual logical printers associated with the comprehensive logical printer according to an instruction from the user. In other words, a print job input to the comprehensive logical printer is input to any one of the individual logical printers. Thereafter, the print job can be printed by the physical printer associated with the individual logical printer.

The registration control unit 705 of the print server 130 may be able to register the comprehensive logical printer and the individual logical printer in the print server 130 according to an instruction from the user of the printing apparatus 500 or an administrator of the printing system, for example. For example, as described above, in S808 of FIG. 8, the registration control unit 403 of the print server 130 registers the logical printer. The logical printer is registered as an individual logical printer due to it being associated with a specific physical printer. Also, in a case where the comprehensive logical printer is already registered with a tenant of the cloud to which the user who registered the physical printer belongs to, the registration control unit 403 of the print server 130 may associate the newly registered individual logical printer to the comprehensive logical printer.

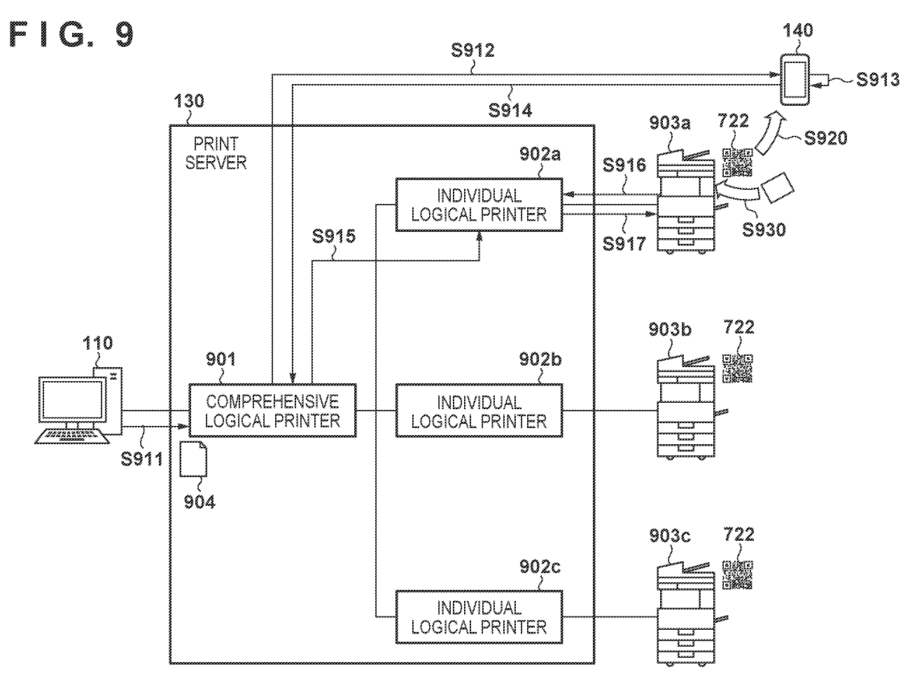

An example of a comprehensive logical printer and an individual logical printer provided by the print server 130 will now be described with reference to FIG. 9. The print server 130 functions as a virtual printer. A virtual printer is a logical printer associated with a print queue and treated as a single virtual printer. In the example of FIG. 9, one comprehensive logical printer 901 and three individual logical printers 902a to 902c are registered in the print server 130, and the print server 130 provides these four logical printers. The three individual logical printers 902a to 902c are all associated with the comprehensive logical printer 901. Also, the three individual logical printers 902a to 902c are each individually associated with three physical printers 903a to 903c, respectively. For example, the individual logical printer 902a is associated with only the physical printer 903a of the three physical printers 903a to 903c. The physical printers 903a to 903c may include a configuration similar to that of the printing apparatus 500. The physical printers 903a to 903c may be connected to the same LAN 101 as the information processing apparatus 110 as with the printing apparatus 120 or may not be connected to the same LAN 101 as the information processing apparatus 110 as with the printing apparatus 121.

The processing flow of printing when a print job is input to the comprehensive logical printer 901 will now be described with reference to FIG. 9. In S911, the print control unit 404 of the information processing apparatus 110 inputs a print job 904 to the comprehensive logical printer 901 (S814 of FIG. 8). At this stage, the user of the information processing apparatus 110 does not need to designate which physical printer to use for printing.

In S912, the user who input the print job 904 or another user logs into the portable communication apparatus 140 and obtains the print job input to the comprehensive logical printer 901. In S913, a print job list is displayed on the portable communication apparatus 140 of the user. Then, the user designates a desired print job from the print job list displayed on the portable communication apparatus 140 and designates the physical printer to perform printing. The operations in S913 are performed via an application of the portable communication apparatus 140. In this example, the user designates the print job 904 from the print job list on the portable communication apparatus 140 and designates the physical printer 903a as the physical printer to perform printing.

In S914, the print server 130 is instructed to move the print job 904 input to the comprehensive logical printer 901 to the individual logical printer 902a so that printing can be performed by the physical printer 903a. The instruction includes the identification information (job ID) of the job to be moved and the cloud printer ID of the individual logical printer 902a that is the movement destination.

The job management unit 304 of the print server 130 receives an instruction from the user and, in S915, moves the print job 904 from the comprehensive logical printer 901 to the individual logical printer 902a. Accordingly, since the print job 904 is associated with the individual logical printer 902a, the print job 904 can be printed by the physical printer 903a.

In S916, the CP control unit 707 of the physical printer 903a transmits a print job request to the individual logical printer 902a (S816 of FIG. 8). In S917, the print control unit 302 of the print server 130 transmits a print job response to the physical printer 903a in response to receiving the print job request from the physical printer 903a (S817 of FIG. 8). The print job response includes the print job 904. Thereafter, the print processing unit 704 of the physical printer 903a performs printing based on the print job 904 (S818 of FIG. 8).

In the description of FIG. 9, an instruction to print the print job 904 input to the comprehensive logical printer 901 with the individual logical printer 902a is selected from the print job list displayed on the portable communication apparatus 140, and the physical printer is designated. The instruction to print the print job 904 input to the comprehensive logical printer 901 with the individual logical printer 902a may be issued by a two-dimensional code displayed on the physical printer 903a being scanned by the portable communication apparatus 140. The two-dimensional code 722 is an encoded cloud printer ID corresponding to the printing apparatus 903a. The cloud printer ID is an ID representing the individual logical printer 902a.

The instruction includes the cloud printer ID of the individual logical printer 903a that is the movement destination and user identification information that identifies the user. The user identification information may be any identification information that can identify a user. For example, a user ID may be used. A printing instruction can be issued to the individual logical printer 903a using the user identification information without the print job 904 being identified.

In a case where a printing instruction is issued using a two-dimensional code, in S920, the user points the camera 209 at the two-dimensional code 722 displayed on the printing apparatus 903a so that the portable communication apparatus 140 can scan the two-dimensional code 722. Thereafter, the portable communication apparatus 140 obtains the cloud printer ID corresponding to the printing apparatus 903a represented by the two-dimensional code 722 by decoding the two-dimensional code 722. Then, in S914, the portable communication apparatus 140 transmits the user identification information identifying the portable communication apparatus 140 and the obtained cloud printer ID to the print server 130.

The instruction to print the print job 904 input to the comprehensive logical printer 901 with the individual logical printer 902a can be issued from the physical printer 903a. In a case where execution of a print job is instructed using the physical printer 903a, in S930, the instruction is issued by an IC card or the portable communication apparatus 140 being brought close to a card scanning unit (not illustrated) of the physical printer 903a. Also, on the login screen, a user ID (user identification information) and password may be input from the display panel 601. The user identification information can be obtained from the scanned IC card or the portable communication apparatus 140. The user identification information can also be obtained from the user identification information input on the login screen. In a case where an instruction to print the print job 904 is issued from the physical printer 903a, the obtained user identification information and the cloud printer ID of the individual logical printer 902a identifying itself are transmitted to the print server 130.

The job management unit 304 of the print server 130 that received the print request issues an instruction to execute the print job to the physical printer 903a corresponding to the cloud printer ID included in the print request. First, the physical printer 903a issues an obtain print job request to the comprehensive logical printer 901. In the obtain request, the user identification information and the cloud printer ID are included.

Of the print jobs input to the comprehensive logical printer 901 and being held, the print job input by the user identified by the user identification information is moved from the comprehensive logical printer 901 to the individual logical printer 902a. At this time, the print job to be moved includes the print job 904, but another print job input by the user identified by other user identification information may also be included.

The CP control unit 707 of the physical printer 903a transmits the print job request to the individual logical printer 902a. The print control unit 302 of the print server 130 transmits a print job response to the physical printer 903 in response to receiving the print job request from the physical printer 903a. The print job response includes the print job moved to the individual logical printer 902a. Thereafter, the print processing unit 704 of the physical printer 903a performs printing based on the print job.

In a case where the user identification information is identified and printing is performed by the physical printer 903a, the print jobs input by the user identified by the user identification information are all included. Instead of executing all of the print jobs, a list of the print jobs identified by the user identification information may be displayed on the display panel 601 of the physical printer 903a, and the user may select the desired print job from the list of print jobs to perform printing.

In the example described above, the user issues an instruction to move the print job 904 from the comprehensive logical printer 901 to the individual logical printer 902a, but the print job 904 may be instructed to be moved to the individual logical printer 902b or 902c. In this case, printing is performed by the physical printer 903b or 903c. In this manner, the user can perform printing using any of the physical printers 903a to 903c after the print job 904 has been input to the print server 130. Such a printing method may be referred to as hold printing or pull printing.

### Installation of Print Support Application (PSA) in Information Processing Apparatus

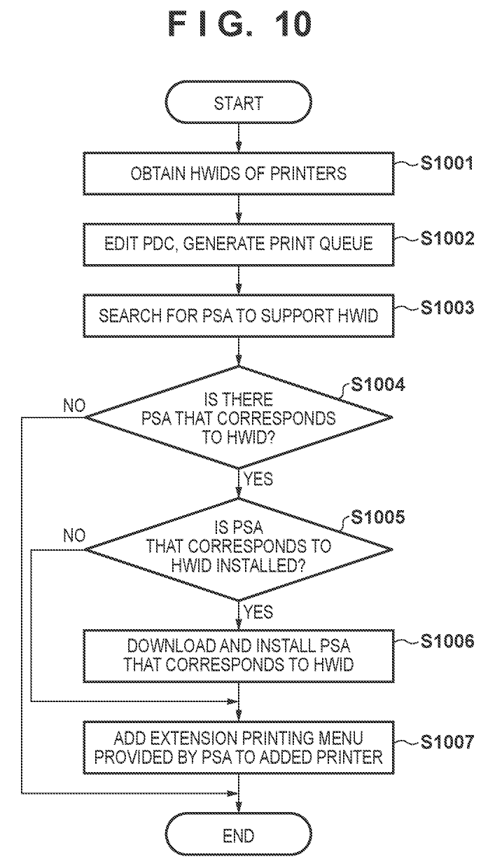

Next, installation of the print support application (PSA) 413 in the information processing apparatus 110 will be described with reference to FIG. 10. The processing described below is implemented by the CPU 201 of the information processing apparatus 110 reading out a program stored in the ROM 203 onto the RAM 202 and executing the program, for example. Hereinafter, the step number of each processing included in the flowchart will be indicated by a number preceded by “S”. This is the same for subsequent flowcharts also.

Installation of the PSA 413 is performed in a case where the information processing apparatus 110 adds a printer. First, in S1001, the printer management unit 405 of the information processing apparatus 110 uses the function of the OS 412, performs a search for printers connected to the network, and obtains printer names and hardware IDs (HWID). A HWID is a vendor-defined identification character string used for the OS 412 to compare the printer with a printer driver package.

Next, in S1002, the printer management unit 405 of the information processing apparatus 110 uses the function of the OS 412 to obtain the printer configuration information. The configuration information is obtained by obtaining each item of the capability information of the printer. When the configuration information is obtained, the OS 412 edits the printer device function (PDC) in the information processing apparatus 110 and generates a print queue for the added printer.

Next, in S1003, the printer management unit 405 uses the obtained HWID and searches for a PSA to support the HWID from the server providing the PSA. The PSA is different depending on the vendor and printer model, and thus the HWID and the PSA are associated together. The HWID and the PSA may be associated 1-to-1, or one PSA may be associated with a plurality of HWIDs. The server that provides the PSA may be a server of the provider of the OS 412 or may be a server provided by the printer vendor. In S1004, the printer management unit 405 determines whether or not there is a PSA that corresponds to the HWID. If there is not a PSA that corresponds to the HWID, the processing ends. If there is a PSA that corresponds to the HWID, the CPU 201 advances the processing to S1005.

Next, the printer management unit 405 determines whether or not the PSA that corresponds to the HWID is already installed in the information processing apparatus 110. If the PSA is not installed in the information processing apparatus 110 (in the case of no), the CPU 201 advances the processing to S1006 and downloads and installs a PSA that corresponds to the HWID. The downloaded and installed PSA is stored in the storage control unit 410.

After S1006, the printer management unit 405 advances the processing to S1007. In S1005, in a case where a PSA that corresponds to the HWID is installed in the information processing apparatus 110 (in the case of yes), the printer management unit 405 skips S1005 and advances the processing to S1007. In S1007, the printer management unit 405 adds an extension printing menu provided by the PSA to the added printer.

In this manner, the information processing apparatus 110 can add a printer, download the PSA 413 that corresponds to the added printer, and install the PSA 413. After the PSA 413 is installed, by adding a vendor extension attribute to the standard print function of the OS, the user can use the extended print setting specified by the vendor extension attribute. In this manner, when the information processing apparatus 110 adds a printer, a print queue for storing print jobs is generated corresponding to the printer, and one PSA corresponding to the print queue is supported.

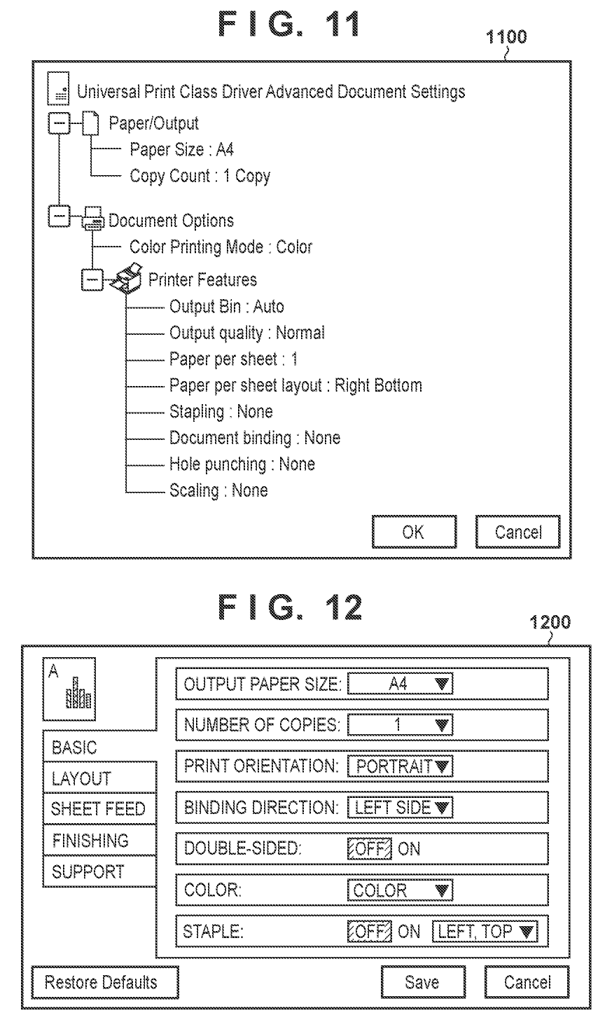

A print settings screen 1100 illustrated in FIG. 11 is a standard print settings screen provided by the OS 412. The standard print settings screen 1100 is a user interface in a tree view format that provides only the standard print function. When the PSA 413 is installed in the information processing apparatus 110, print settings using a print settings screen 1200 illustrated in FIG. 12 corresponding to the vendor extended print setting are enabled. The print settings screen 1200 provides a user interface similar to the print settings screen provided by the printer driver. In addition to the standard print settings, with the print settings screen 1200, the extended print settings can be provided.

The operations of the print settings using the PSA 413 will now be described. The OS 412 of the information processing apparatus 110 manages the information related to the printers that can be input with a print job as the printer information 411. The printer information 411 is managed as the PDC (printer device function) and includes the names of printers, capability information, and the like.

In a case where the user of the information processing apparatus 110 performs printing of print data, the OS 412 displays the information related to a printer that can perform printing. The user selects a printer to input a print job from the printer that can perform printing. The OS 412 displays the name of the printer and detailed information (properties) as the information related to the printer that can perform printing. The user sets the print settings by selecting the detailed information (properties). In a case where a PSA that corresponds to the printer has not been installed, when the detailed information (properties) is selected, the standard print settings screen 1100 of FIG. 11 is displayed, and the print settings can be set.

On the other hand, in a case where the PSA 413 that corresponds to the printer is installed, the OS 412 provides the PSA 413 with the printer information 411 (PDC). The PSA 413 edits the PDC object of the provided PDC and passes the edited content to the OS 412. When the user selects the printer (print queue) and selects the detailed information (properties) of the printer, the PSA 413 is activated, and the print settings screen 1200 where the extended print settings of FIG. 12 can be set is displayed. Via these operations, the PSA 413 enables the extended print settings.

### Extended Print Settings

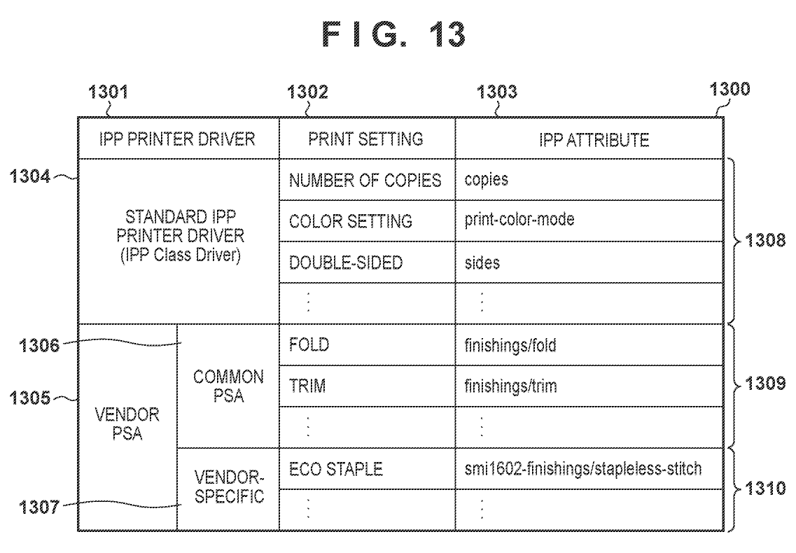

The extended print settings from the vendor will now be described with reference to FIG. 13. Examples of an IPP printer driver include a standard IPP printer driver 1304 and a vendor PSA 1305. A vendor PSA supports the extended print settings in which print settings other than the print settings supported by the standard IPP printer driver are defined by the vendor. The extended print settings by the vendor PSA include two extension methods: a method of extension via IPP standard attributes and an extension method of defining IPP extension attributes specific to the vendor. In FIG. 13, Common PSA 1306 corresponds to extended IPP standard attributes. Also, Vendor specific 1307 corresponds to extended print settings of IPP extension attributes defined as vendor-specific. Extended print settings defined as vendor-specific are disabled for printers of different vendors. Also, the extended print settings of a common PSA may also be disabled.

FIG. 13 illustrates Print settings 1302 and IPP attributes 1303 for each driver 1301. The standard IPP printer driver 1304 supports the standard print settings. Examples of the print settings of the standard IPP printer driver 1304 of the IPP printer driver include number of copies to print, color settings, double-sided printing, and similar settings as indicated at 1308. With the IPP standard print settings, the print settings are set with the number of copies corresponding to IPP attribute copies, the color setting corresponding to IPP attribute print-color-mode, and double-sided printing corresponding to IPP attribute sides.

The common PSA 1306 of the vendor PSA 1305 is not as standard as the standard print settings provided by the standard IPP printer driver 1304 but supports print settings 1309 defined by IPP standard attributes. Examples include fold and trim of finishing processing and the like. Fold uses finishings/fold of IPP standard attributes, and trim uses finishings/trim of IPP standard attributes. Since the common PSA uses IPP standard attributes, it may support printers of other vendors.

The vendor PSA, in addition to the print settings by the common PSA 1306, defines the vendor-specific extended print settings 1307 via IPP extension attributes and supports them. An IPP extension attribute is an IPP attribute specifically set by the vendor. Examples of a vendor-specific extended print setting includes eco staple and the like. In the eco staple print setting of FIG. 13, smi1602-finishings/stapleless-stitch is defined as user-specific as an IPP extension attribute. The extended print settings are not necessarily supported even if they are for printers of the same vendor. Typically, the printers of other vendors are not supported.

### Extended Print Settings Screen

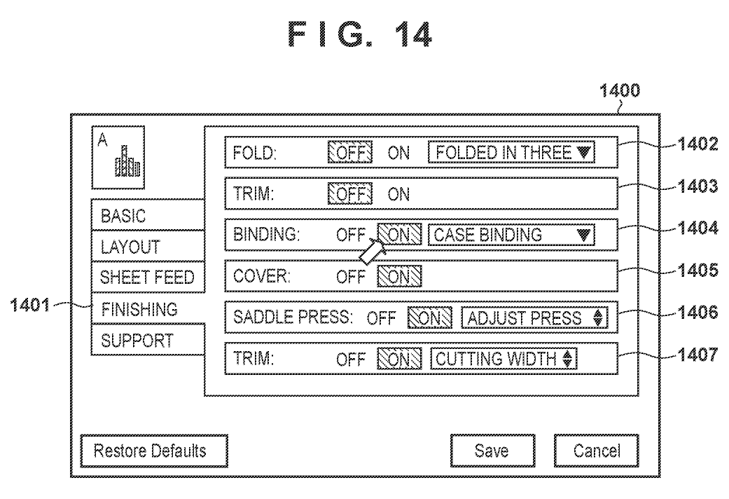

The extended print settings will now be described with reference to FIG. 14. A print settings screen 1400 of FIG. 14 is the print settings screen 1200 of FIG. 12 in a state in which a finishing tag 1401 is selected. As finishing processes, Fold 1402, Trim 1403, Binding 1404, Cover 1405, Saddle press 1406, and Cut 1407 are settable. Fold 1402 represents folding of the printed sheet. This includes folded in two, folded in three, folded in four, and the like. Trim 1403 represents trimming of the printed sheet. Binding 1404 represents saddle stitch binding and case binding, and with saddle stitch binding, the printed sheet is folded in the center and stapled at the center. Case binding is binding in which the cover is closed with glue and wrapped. Cover 1405 represents adding a cover to the binding. Saddle press 1406 is for suppressing a bulge in the saddle press portion when the back is pressed at the time of saddle pressing. Cut 1407 represents aligning the post-saddle-press-binding cross section. Fold 1402 and Trim 1403 are extended print settings set in the common PSA of FIG. 13. The extended print settings use the IPP standard attributes.

On the other hand, the case binding is an attribute defined in the IPP extension attributes as vendor-specific. In this manner, by installing the PSA 413 in the information processing apparatus 110, printing can be performed using the extended print settings not supported in the standard print settings (the standard print settings screen 1100).

### Network Configuration of Printing System including Printers of a Plurality of Vendors

A HWID of a printer is allocated per type of printer. A HWID is also allocated to a comprehensive logical printer of cloud printing. On the basis of the HWID of the comprehensive logical printer 901, the information processing apparatus 110 downloads and installs the PSA 413 that corresponds to the comprehensive logical printer in the information processing apparatus 110.

In the case of a printing system that forms a cloud print service, for example, in the printing system of FIG. 9, the print server 130 and the physical printers 903a to 903c may be configured of a product of the same vendor. In this case, in the information processing apparatus 110, the user can use the extended print settings used by the PSA 413 and perform printing using the extended print settings from any one of the physical printers 903a to 903c.

On the other hand, physical printers of a plurality of vendors may be registered for the comprehensive logical printer 901. In the case of using the extended print settings in the PSA 413 that corresponds to the comprehensive logical printer 901, when pull printing is performed with a physical printer of the same vendor, printing based on the extended print settings can be performed. However, with a physical printer of another vendor, since the extended print settings corresponding to the comprehensive logical printer 901 is not supported, printing is performed after disabling the settings from the extended print settings.

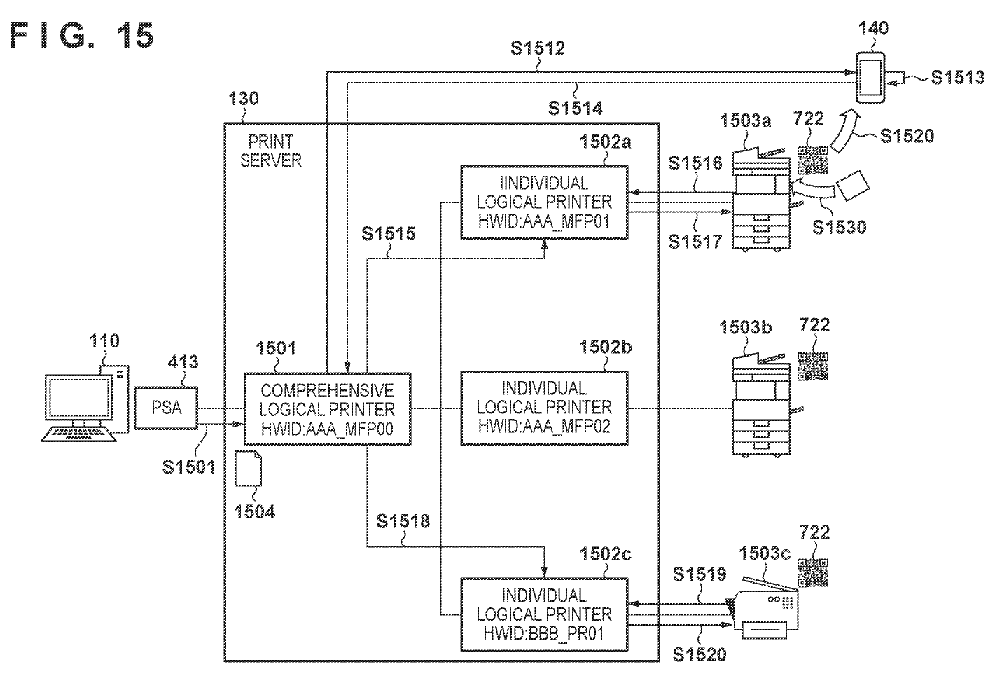

The configuration of a printing system including physical printers of a plurality of vendors will now be described with reference to FIG. 15. The description of parts that are also in FIG. 9 will be skipped. Also, in the following description, processing for operating pull printing from the portable communication apparatus 140 of the user will be mainly described. Being able to issue a pull printing instruction via scanning a two-dimensional code and via a physical printer is the same as described in FIG. 9.

In the example of FIG. 15, a single comprehensive logical printer 1501 and three individual logical printers 1502a to 1502c associated with the comprehensive logical printer 1501 are registered in the print server 130. Also, the three individual logical printers 1502a to 1502c are each individually associated with three physical printers 1503a to 1503c, respectively.

A HWID is associated with each of the comprehensive logical printer 1501 and the individual logical printers 1502a to 1502c and managed. The HWID includes information for identifying a vendor representing the manufacturing source of the hardware and information for identifying the device. The information for identifying the device may include information for identifying the printer series. The print server 130 functions as a virtual printer, and the HWID of the comprehensive logical printer 1501 is AAA_MFP00. The HWID represents the vendor “AAA company” and the model name “MFP00”. The print server 130 does not perform printing, and thus the vendor and model name of the HWID of the comprehensive logical printer 1501 is virtually allocated. For the HWID, the vendor and model name shared by individual physical printers associated with the comprehensive logical printer 1501 may be allocated or another model name may be allocated. Also, only the information for identifying the vendor may be used.

The physical printer 1503a is model MFP01 from AAA company, and the individual logical printer 1502a includes a HWID of AAA_MFP01. The physical printer 1503b is model MFP02 from AAA company, and the individual logical printer 1502b includes a HWID of AAA_MFP02. The physical printer 1503c is model PR01 from BBB company, and the individual logical printer 1502c includes a HWID of BBB_PR01.

The processing flow of printing when a print job is input to the comprehensive logical printer 1501 will now be described with reference to FIG. 15. The information processing apparatus 110, according to the flow of FIG. 10, installs the PSA 413 corresponding to AAA_MFP00, the HWID of the comprehensive logical printer 1501. In S1501, the print control unit 404 of the information processing apparatus 110 inputs a print job 1504 to the comprehensive logical printer 1501. The print job 1504 has the print settings via the extended print settings from the PSA 413. At this stage, the user of the information processing apparatus 110 does not need to designate which physical printer to use for printing.

In S1512, the user who input the print job 1504 or another user logs into the portable communication apparatus 140 and obtains the print job input to the comprehensive logical printer 1501. In S1513, a print job list is displayed on the portable communication apparatus 140 of the user. Then, the user designates a desired print job from the print job list displayed on the portable communication apparatus 140 and designates the physical printer to perform printing. The operations in S1513 are performed via an application of the portable communication apparatus 140. In this example, the user designates the print job 1504 from the print job list on the portable communication apparatus 140 and designates the physical printer 1503a as the physical printer to perform printing.

In S1514, the user uses the portable communication apparatus 140 to issue an instruction for printing to be performed by the physical printer 1503a. The portable communication apparatus 140 instructs the print server 130 to move the print job 1504 input to the comprehensive logical printer 1501 to the individual logical printer 1502a. The instruction includes the identification information (job ID) of the job to be moved and the cloud printer ID of the individual logical printer 1502a that is the movement destination.

In S1515, the job management unit 304 of the print server 130 moves the print job 1504 from the comprehensive logical printer 1501 to the individual logical printer 1502a. Accordingly, since the print job 1504 is associated with the individual logical printer 1502a, the print job 1504 can be printed by the physical printer 1503a.

In S1516, the CP control unit 707 of the physical printer 1503a transmits a print job request to the individual logical printer 1502a. In S1517, the print control unit 302 of the print server 130 transmits a print job response to the physical printer 1503a in response to receiving the print job request from the physical printer 1503a. The print job response includes the print job 1504. Thereafter, the print processing unit 704 of the physical printer 1503a performs printing based on the print job 1504. At this time, the comprehensive logical printer 1501 and the physical printer 1503a are of the same vendor, AAA company. Thus, the print job 1504 set for printing with the extended print settings from the PSA 413 is executed for printing with the extended print settings applied.

Next, in S1513, the user designates the print job 1504 from the print job list on the portable communication apparatus 140 and designates the physical printer 1503c as the physical printer to perform printing. In S1514, the print server 130 is instructed to move the print job 1504 input to the comprehensive logical printer 1501 to the individual logical printer 1502c so that printing can be performed by the physical printer 1503c. The instruction includes the identification information (job ID) of the job to be moved and the cloud printer ID of the individual logical printer 1502c that is the movement destination.

In S1518, the job management unit 304 of the print server 130 moves the print job 1504 from the comprehensive logical printer 1501 to the individual logical printer 1502c. Accordingly, since the print job 1504 is associated with the individual logical printer 1502c, the print job 1504 can be printed by the physical printer 1503c.

In a case where a printing instruction is issued using a two-dimensional code, in S1520, the user points the camera 209 at the two-dimensional code 722 displayed on the physical printer 1503a so that the portable communication apparatus 140 can scan the two-dimensional code 722. Thereafter, the portable communication apparatus 140 obtains the cloud printer ID corresponding to the physical printer 1503a represented by the two-dimensional code 722 by decoding the two-dimensional code 722. Then, in S1514, the portable communication apparatus 140 transmits the user identification information identifying the portable communication apparatus 140 and the obtained cloud printer ID to the print server 130.

The instruction to print the print job 1504 input to the comprehensive logical printer 1501 with the individual logical printer 1502a can be issued from the physical printer 1503a. In a case where execution of a print job is instructed using the physical printer 1503a, in S1530, the instruction is issued by an IC card or the portable communication apparatus 140 being brought close to a card scanning unit (not illustrated) of the physical printer 1503a. Also, on the login screen, a user ID (user identification information) and password may be input from the display panel 601. The user identification information can be obtained from the scanned IC card or the portable communication apparatus 140. The user identification information can also be obtained from the user identification information input on the login screen. In a case where an instruction is issued from the physical printer 1503a, the obtained user identification information and the cloud printer ID of the individual logical printer 1502a identifying itself are transmitted to the print server 130.

In S1519, the CP control unit 707 of the physical printer 1503c transmits a print job request to the individual logical printer 1502c. In S1517, the print control unit 302 of the print server 130 transmits a print job response to the physical printer 1503c in response to receiving the print job request from the physical printer 1503c. The print job response includes the print job 1504. Thereafter, the print processing unit 704 of the physical printer 1503c performs printing based on the print job 1504.

At this time, the vendor of the comprehensive logical printer 1501 is AAA company, but the vendor of the physical printer 1503c is BBB company, thus the vendors of the comprehensive logical printer 1501 and the physical printer 1503c are different. Accordingly, since the extended print settings from the PSA 413 cannot be interpreted in the physical printer 1503c, the extended print settings are ignored and printing is performed. Thus, the user who input the print job 1504 set with the print settings via the extended print settings obtains a printing result without the extended print settings applied.

The PSA 413 corresponding to the comprehensive logical printer 1501 obtains the information of the individual logical printer associated with the comprehensive logical printer 1501 from the print server 130. As the information of the individual logical printer, the HWID of the physical printer may be used or other information may be used. As the information of the individual logical printer, it is sufficient that the information identifies the vendor and model of the printer.

In the printing system of FIG. 15, the three individual logical printers 1502a to 1502c associated with the comprehensive logical printer 1501 are registered. The PSA 413 obtains the HWID of the three individual logical printers 1502a to 1502c associated with the comprehensive logical printer 1501 from the print server 130. The PSA 413 obtains AAA_MFP01, AAA_MFP02, and BBB_PR01, which are the HWIDs of the three individual logical printers 1502a to 1502c, from the print server 130.

The print settings in the case of performing cloud printing in a printing system including printers of a plurality of vendors will now be described with reference to FIG. 15. In FIG. 15, to perform cloud printing, the user inputs the print job 1504 to the comprehensive logical printer 1501 from the information processing apparatus 110. The individual logical printers 1502a and 1502b of AAA company and the individual logical printer 1502c of BBB company are registered in association with the comprehensive logical printer 1501 provided by AAA company.

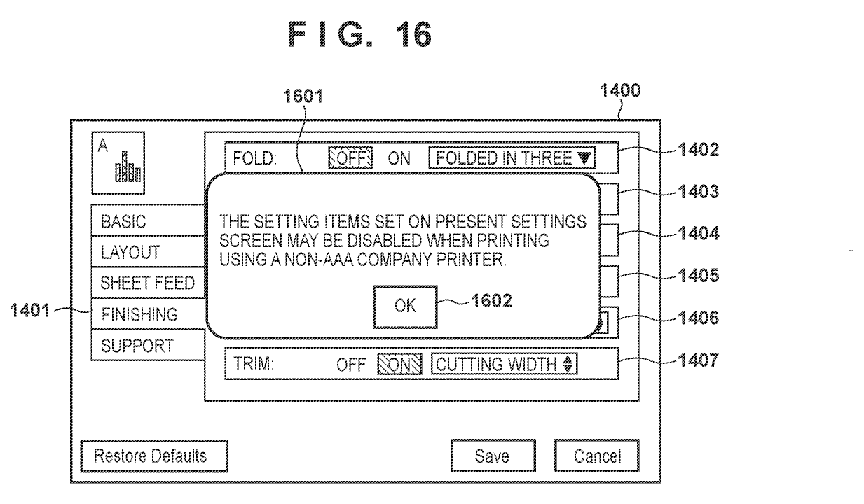

The user sets the print settings for inputting a print job. Here, the user sets the print settings via the extended print settings screen 1400 of FIG. 14. Fold 1402, Trim 1403, Binding 1404, Cover 1405, Saddle press 1406, and Cut 1407 set in the finishing tag 1401 all correspond to the extended print settings. In this example, the user selects on for the off/on button for binding. When this occurs, a warning display screen 1601 is displayed to the user via a popup saying “The setting items set on the present settings screen may be disabled when printing using a non-AAA company printer” as illustrated in FIG. 16. When the user operates an OK button 1602, the warning display screen 1601 is closed. In the content of the warning display screen 1601, a printer that can perform printing may be identify, such as in a display saying “The setting items set on the present settings screen are enabled only when printing with an AAA company printer.” Also, in the warning display screen 1601, the display may correspond to the extended print setting selected, such as in a display saying “This setting item may be disabled when printing with a non-AAA company printer.” Also, in a case where the print settings set in the finishing tag 1401 are all extended print settings and the finishing tag 1401 is selected, the warning display screen 1601 may be displayed.

In a case where the user sets the print settings, confirms the warning display screen 1601, and performs printing with a printer other than an AAA company printer, the user can understand that there is a possibility of the print settings being disabled. Thus, the user can reliably apply the PSA extended print settings set for the comprehensive logical printer 1501 to the print job.

### Modification Example 1

In FIG. 16, the warning display screen 1601 is displayed in the case of setting the extended print settings. However, among the setting items of the extended print settings, there are extension items via the IPP standard attributes. Examples include fold, trim, and the like set in the common PSA of FIG. 13. The extended print settings extended via the IPP standard attributes may be set with similar extended print settings as another vendor. Thus, the print settings from the extended print settings extend via the IPP standard attributes may be reflected in the print settings when printing is performed with a printer of another vendor.

In Modification Example 1, whether or not to display a warning display screen is determined by whether an item of the extended print settings is an extension via the IPP standard attributes or a vendor-specific extension. In FIG. 14, case binding of Binding 1404 is an extended print setting defined by the IPP extension attribute specifically provided by the vendor. Take an example in which the user tries to set case binding when setting the printing item. When this occurs, as illustrated in FIG. 16, the PSA 413 displays the warning display screen 1601 to the user via a popup on the print settings screen 1400. The content displayed on the warning display screen 1601 is, for example, “The setting items set on the present settings screen may be disabled when printing with a non-AAA company printer”. When the user operates the OK button 1602, the warning display screen 1601 is closed.

In a case where the user sets the print settings, confirms the warning display screen 1601, and performs printing with a printer other than an AAA company printer, the user can understand that there is a possibility of the vendor-specific specific printing item settings being disabled. In a case where a vendor-specific extension printing item is selected, the warning display screen 1601 is displayed. However, no such limitation is intended, and in a case where the print settings of the finishing tag 1401 are extended print settings defined by the IPP extension attributes specifically provided by the vendor, when the finishing tag is selected, the warning display screen 1601 may be displayed. Also, in the content of the warning display screen 1601, a printer that can perform printing may be identify, such as in a display saying “The setting items are enabled only when printing with an AAA company printer.”

### Second Embodiment

The second embodiment will be described next. In the IPP, in a case where an IPP client transmits an IPP request (create-job, print-job), client information (client-info) is added as a client attribute. Client-info includes information for identifying the client and the name and version of the software package. In a case where the printer supports this client-info attribute, the printer, when processing a print job, copies this attribute to the corresponding job status attribute of the same name and executes processing.

The client-info attribute is constituted by the following member attributes.

client-name (name (127))

client-patches (text (127)/no-value)

client-string-version (text (127))

client-version (octetString(64)/no-value)

client-type (type2 enum)

The client-name attribute indicates the client name. The client-patches attribute indicates the patch installed in the client. The client-string-version indicates the version number of the client. The client-version(octetString(64)/no-value) indicates the version of the client in machine language. The client-type indicates the module described by the collection. When the client-type is 3, the application is indicated. When the client-type is 4, the operating system (OS) is indicated. When the client-type is 5, the printer driver or another driver is indicated. When the client-type is 6, another type of the software of the client is indicated.

In a case where the client generates a print job and requests the printer to execute the print job, the client may combine a plurality pieces of client-info to form a set. In this manner, the OS information, the application information, and the like can be added to the print job and transmitted.

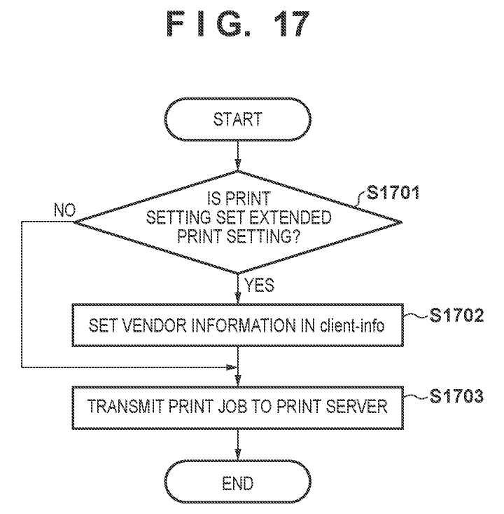

In the present embodiment, in a case where the information processing apparatus 110 inputs a print job to the comprehensive logical printer 1501, PSA vendor information is set with the client-info. The processing of the information processing apparatus 110 according to the present embodiment will now be described with reference to FIG. 17. The processing described below is implemented by the CPU 201 of the information processing apparatus 110 reading out a program stored in the ROM 203 onto the RAM 202 and executing the program, for example.

The flow of FIG. 17 is started when the user generates a print job in the information processing apparatus 110. The user selects a print settings item on the print settings screen 1200 or the print settings screen 1400. In S1701, the print control unit 404 of the information processing apparatus 110 determines whether or not the print setting set by the user on the print settings screen 1200 or the print settings screen 1400 is an extended print setting from the PSA 413 of the vendor. In S1701, in a case where the print setting set by the user is an extended print setting from the PSA 413 of the vendor (yes), the print control unit 404 advances the processing to S1802. On the other hand, in S1701, in a case where it is a print setting from the standard print setting (no), the print control unit 404 of the information processing apparatus 110 skips S1802 and advances the processing to S1703.

In S1702, the PSA 413 of the information processing apparatus 110 sets the vendor information to the client-info. The PSA 413 has been downloaded and installed by the information processing apparatus 110 according to the HWID of the printer. In this case, the PSA 413 corresponds to the HWID of AAA_MFP00, which is the HWID of the comprehensive logical printer 1501. The PSA 413, as the vendor information set to the client-info, may set the HWID corresponding to the PSA 413 itself or may set, of the HWIDs, only the information of AAA indicating the vendor. When the vendor information is set to the client-info, the PSA 413 advances the processing to S1703.

In S1703, the print control unit 404 of the information processing apparatus 110 transmits the print job with the client-info added to the print server 130. In the case of extended print setting, the vendor information is set to the client-info added to the print job.

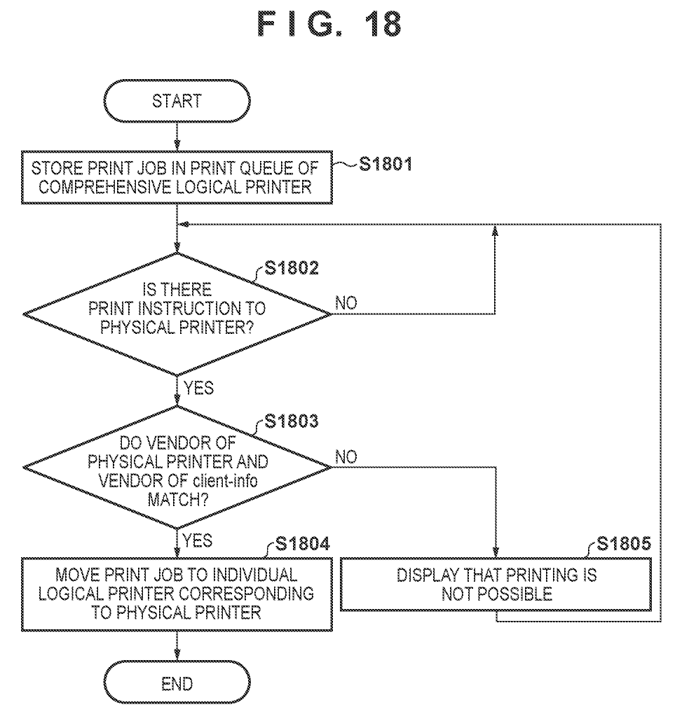

Next, the processing of the print server 130 that received the print job from the information processing apparatus 110 will be described with reference to FIG. 18. The processing described below is implemented by the CPU 201 of the print server 130 reading out a program stored in the ROM 203 onto the RAM 202 and executing the program, for example.

The flow of FIG. 18 is started when the print server 130 receives a print job from the information processing apparatus 110. In S1801, when the job management unit 304 of the print server 130 receives a print job from the information processing apparatus 110, the job management unit 304 stores the print job in the print queue of the comprehensive logical printer 1501. The information of the print job is managed as the job information 312.

In S1802, the print control unit 302 of the print server 130 waits until there is a printing instruction for the physical printer. By the user instructing one of the physical printers 1503a to 1503c using the portable communication apparatus 140 of FIG. 15, the one of the physical printers 1503a to 1503c is instructed to execute the print job. The print job execution instruction may be performed by the user scanning a two-dimensional code with the portable communication apparatus 140 or an operation via an IC card from the one of the physical printers 1503a to 1503c of FIG. 15.

In this example, the user uses the portable communication apparatus 140 to issue an instruction for printing by the physical printer 1503a. In S1802, since there has been a printing instruction, the print control unit 302 of the print server 130 advances the processing to S1803.

In S1803, the print control unit 302 of the print server 130 determines whether the vendor of the physical printer and the vendor of the client-info of the print job match. The information of the vendor of the physical printer is managed by the printer management unit 303 as the printer information 311 of the individual logical printer corresponding to the physical printer. Since the vendor AAA of the HWID of the individual logical printer 1502a corresponding to the physical printer 1503a and the vendor information AAA of the client-info match (yes), the print control unit 302 of the print server 130 advances the processing to S1804.

In S1804, the print control unit 302 of the print server 130 moves the print job to the individual logical printer 1502a. The print job moved to the individual logical printer 1502a is output via printing by printing being performed by the physical printer 1503a.

In this example, the user uses the portable communication apparatus 140 to issue an instruction for printing by the physical printer 1503c. In S1802, since there has been a printing instruction, the print control unit 302 of the print server 130 advances the processing to S1803.

In S1803, the print control unit 302 of the print server 130 determines whether the vendor of the physical printer and the vendor of the client-info of the print job match. Since the vendor BBB of the HWID of the individual logical printer 1502c corresponding to the physical printer 1503c and the vendor information AAA of the client-info do not match (no), the print control unit 302 of the print server 130 returns the processing to S1802.

In a case where the vendor of the physical printer and the vendor of the PSA 413 of the information processing apparatus 110 input with the print job are different, the settings of the extended print settings from the PSA 413 are not applied. Thus, in a case where the vendor of the physical printer and the vendor of the PSA 413 of the information processing apparatus 110 input with the print job are different, the print job is not moved to the physical printer. In this manner, printing is performed by only the printing apparatus with the same vendor as the vendor of the PSA 413 of the information processing apparatus 110, and printing is not performed by a printing apparatus of a vendor that is not the vendor of the PSA 413. Accordingly, the settings from the extended print settings can be reliably applied to the printing result of the physical printer.

### Modification Example 2

In FIG. 17, in S1701, it is determined whether the print setting is an extended print setting. Even if the print setting is an extended print setting from the PSA 413, in some cases, an extended print setting corresponding to the common PSA of FIG. 15 may support the print setting of a printing apparatus of a vendor that is not the vendor of the PSA 413. Thus, only in a case where the vendor extended print setting 1307 specific to the vendor PSA 413 is set, the vendor information may be set to the client-info.

In this example, of the print settings screen 1400, for example, the case binding of Binding 1404 is a vendor extended print setting specific to the vendor PSA 413. In this example, of the print settings screen 1400, the user sets case binding to on. In S1801, the print control unit 404 of the information processing apparatus 110 determines that the case binding of the print settings corresponds to an extended print setting specific to the vendor PSA and sets the vendor information to the client-info. The subsequent processing is similar to the processing described above and is thus not described.

### Modification Example 3

In S1803 of FIG. 18, in the case of no, the processing returns to S1802. However, the processing of S1805 may be executed. In S1805, a message for displaying that printing cannot be performed with the physical printer is transmitted for instruction to the portable communication apparatus 140 or the physical printer 1503c that executed the printing instruction. By performing such a display, the user can be instructed to performing the printing with another printer.

### Modification Example 4

In S1512 of FIG. 15, the user who input the print job 1504 or another user logs into the portable communication apparatus 140 and obtains the print job input to the comprehensive logical printer 1501. At this time, in a case where the vendor information is added to the print job 1504, the print server 130 may enable printing of the print job 1504 with only the individual logical printers 1502a and 1502b. The printer management unit 405 of the print server 130 manages the vendor information as the printer information 411. In a case where there is a request to obtain the print job from the portable communication apparatus 140, only the printing apparatus of the same vendor as the vendor information added to the print job can be transmitted, together with the print job, as the printing apparatus that can perform printing to the portable communication apparatus 140. The user designates a desired print job from the print job list displayed on the portable communication apparatus 140 and designates the physical printer to perform printing. The operation is performed via an application of the portable communication apparatus 140, and the physical printer performing the printing is designated from the physical printers of the same vendor as the vendor of the PSA 413 of the information processing apparatus 110.

### Third Embodiment

In the second embodiment, in a case where the vendor information added to the print job set with the extended print setting matches the vendor information of the physical printer, the print server 130 moves the print job to the individual logical printer. In the third embodiment, in the physical printer, whether the extended print setting is set is determined via the vendor information added to the print job.

In the present embodiment also, in a case where the information processing apparatus 110 sets the extended print setting to the print job according to the flow of FIG. 17, the vendor information is set with the client information (client-info) and added to the print job. The set of the vendor information is as described above. The print control unit 404 of the information processing apparatus 110 transmits the print job with the client-info added to the print server 130. In the case of an extended print setting, the vendor information is set to the client-info added to the print job.

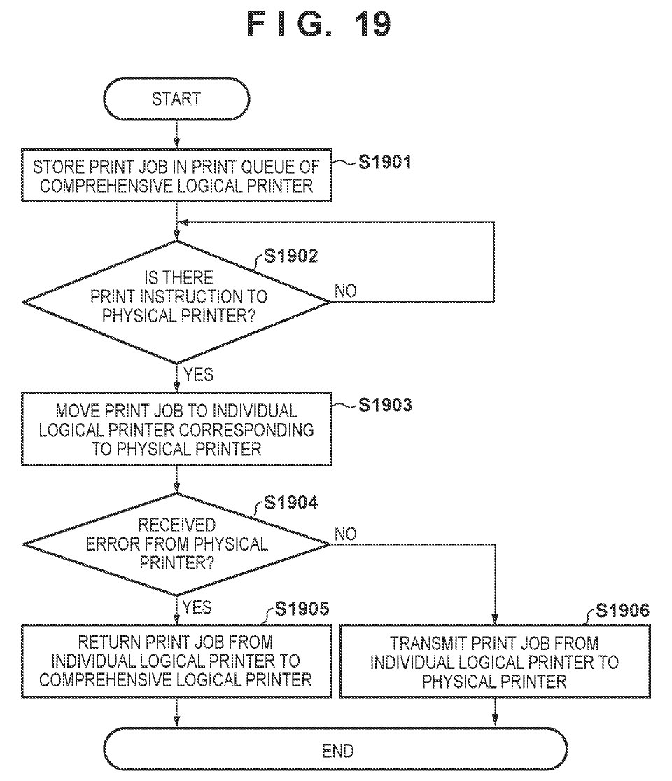

The processing of the physical printers 1503a to 1503c of the print server 130 according to the present embodiment will now be described with reference to FIGS. 19 to 23. First, the processing of the print server 130 that received the print job from the information processing apparatus 110 will be described with reference to FIG. 19. The processing described below is implemented by the CPU 201 of the print server 130 reading out a program stored in the ROM 203 onto the RAM 202 and executing the program, for example.

The flow of FIG. 19 is started when the print server 130 receives a print job from the information processing apparatus 110. In S1901, when the job management unit 304 of the print server 130 receives a print job from the information processing apparatus 110, the job management unit 304 stores the print job in the print queue of the comprehensive logical printer 1501. The information of the print job is managed as the job information 312.

In S1902, the print control unit 302 of the print server 130 waits until there is a printing instruction for the physical printer. By the user instructing one of the physical printers 1503a to 1503c using the portable communication apparatus 140 of FIG. 15, the one of the physical printers 1503a to 1503c is instructed to execute the print job. The print job execution instruction may be performed by the user scanning a two-dimensional code with the portable communication apparatus 140 or an operation via an IC card from the one of the physical printers 1503a to 1503c of FIG. 15.

In this example, the user uses the portable communication apparatus 140 to issue an instruction for printing by the physical printer 1503a. In S1902, since there has been a printing instruction, the print control unit 302 of the print server 130 advances the processing to S1903. In S1903, the print control unit 302 of the print server 130 moves the print job to the individual logical printer 1502a. At this time, the print control unit 302 moves the print job as is with the client-info added to the individual logical printer 1502a. In a case where there is an instruction for the physical printers 1503b and 1503c to perform printing, the print job is moved to each of the individual logical printer 1502b and 1502c. The processing of S1904 onward will be described below.

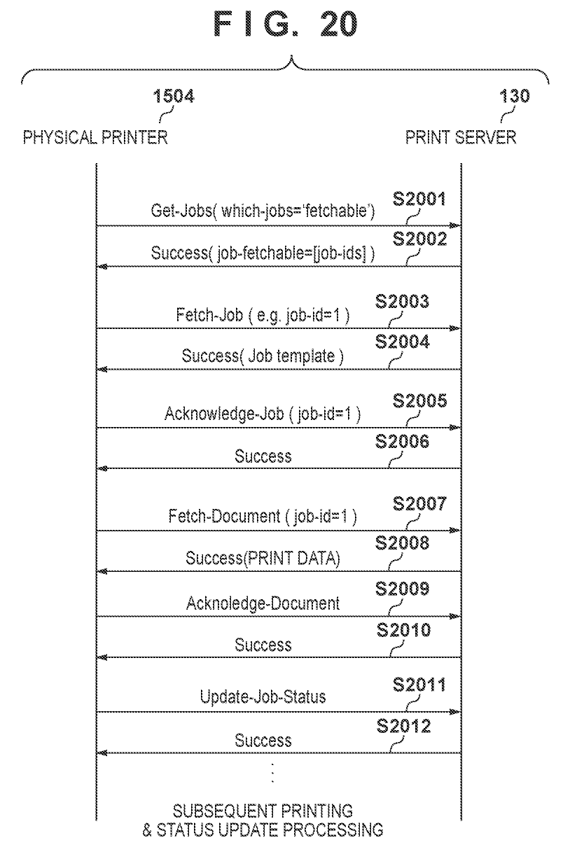

A sequence of the physical printers 1503a to 1503c receives a print job from the print server 130 with reference to FIG. 20 will now be described. FIG. 20 is a sequence diagram illustrating an example of the processing executed in a case where a print job is moved from the comprehensive logical printer 1501 to the individual logical printers 1502a to 1502c. When the print job is moved to the individual logical printers 1502a to 1502c, the print control unit 302 of the print server 130 transmits a receive job event to the physical printers 1503a to 1503c corresponding to each one. The physical printers 1503a to 1503c are collectively referred to as the physical printer 1503 in the following description.

The physical printer 1503 that received the receive job event transmits a Get-Jobs request to the print server 130 (S2001). The physical printer 1503 sets ‘fetchable’ with a which-jobs attribute of the request. The attribute is information indicating a request to inquiry as to whether or not the print job is a print job that can be received.

The print control unit 302 of the print server 130 that received the Get-Jobs request in S2001 determines whether or not the physical printer 1503 is managing a receivable print job. In a case where it is determined that the physical printer 1503 is managing a receivable print job, the print control unit 302 transmits a Success response set including a job-id set with a job-fetchable attribute to the physical printer 1503 (S2002). The job-id is information for identifying the job to be obtained and printed by the physical printer 1503.

In S2002, the physical printer 1503 that received the transmitted response transmits a Fetch-Job request to the print control unit 302 (S2003). The physical printer 1503 receives a job print setting (bibliographic information) as the response to the Fetch-Job request. At this time, the physical printer 1503 sets the job-id of the print job to be obtained from the print control unit 302 with the Fetch-Job request. Hereinafter, the job-id set in S2003 is referred to as the job-id to be obtained.

The print control unit 302 that received the Fetch-Job request transmitted in S2003 transmits a Success response to the physical printer 1503 (S2004). At this time, the print setting of the print job is set with the job-template attribute.

Next, the physical printer 1503 that received a Success response including the print setting determines whether the format of the print setting is normal. In a case where it is normal, the print processing unit 704 of the physical printer 1503 generates a job for internally managing the printing processing. The received print setting is set with the job.

The physical printer 1503 that received that response transmitted in S2004 transmits an Acknowledge-Job request to the print server 130 (S2005). At this time, the job-id to be obtained is set with the job-id attribute. This request is a request for notifying the print server 130 that a job has been received. Note that in a case where it is determined as not normal, the physical printer 1503 transmits information indicating an error in the request and cancels the subsequent document reception processing. Transmission of information indicating an error will be described below.

The print server 130 that received an Acknowledge-Job request transmits a Success response to the physical printer 1503 (S2006).

Next, the physical printer 1503 transmits a Fetch-Document request to the print server 130 (S2007). At this time, the job-id to be obtained is set with the job-id attribute. The request is a print data request.

The print server 130 that received the request transmitted in S2007 transmits the print data together with a Success response to the physical printer 1503 (S2008). Thereafter, the print data corresponding to the job-id to be obtained is transmitted from the print server 130 to the physical printer 1503.

The physical printer 1503 that successfully received the print data transmitted in S2008 transmits an Acknowledge-Document request to the print server 130 (S2009). Note that in a case where some kind of error occurs in the reception, the physical printer 1503 sets the information indicating the error with the request and cancels the subsequent printing processing.

Subsequently, the print server 130 that received the Acknowledge-Document request transmitted in S2009 transmits a Success response to the physical printer 1503 (S2010).

The print processing unit 704 of the physical printer 1503 that received the print data corresponding to the job-id to be obtained associates together the generated job and the print data. The job is submitted to the print queue and printing is sequentially performed on the basis of the queue submission order. The printing processing is implemented via cooperation of the control unit 510 and the printer engine 520.

Subsequently, the physical printer 1503 transmits the processing status of the job to the print server 130 using an Update-Job-Status request (S2011). The request is a request for notifying the print server 130 of the execution status of the job (for example, the job status (whether the status is waiting to print, printing in progress, or the like) or progress status such as how many pages have been printed or the like).

The print server 130 that received the Update-Job-Status request transmitted in S2011 transmits a Success response to the physical printer 1503 (S2012).

Thereafter, the printing processing progresses while repeating the Update-Job-Status exchanges. When the printing processing is successfully completed, the physical printer 1503 notifies the print server 130 that execution of the job is complete via an Update-Job-Status. Also, the physical printer 1503 stores history information in which information indicating success as the execution result and job bibliographic information (for example, page number, number of copies, execution time, document name (file name), and submission user name) are associated together. Pull printing is performed via the sequence described above.

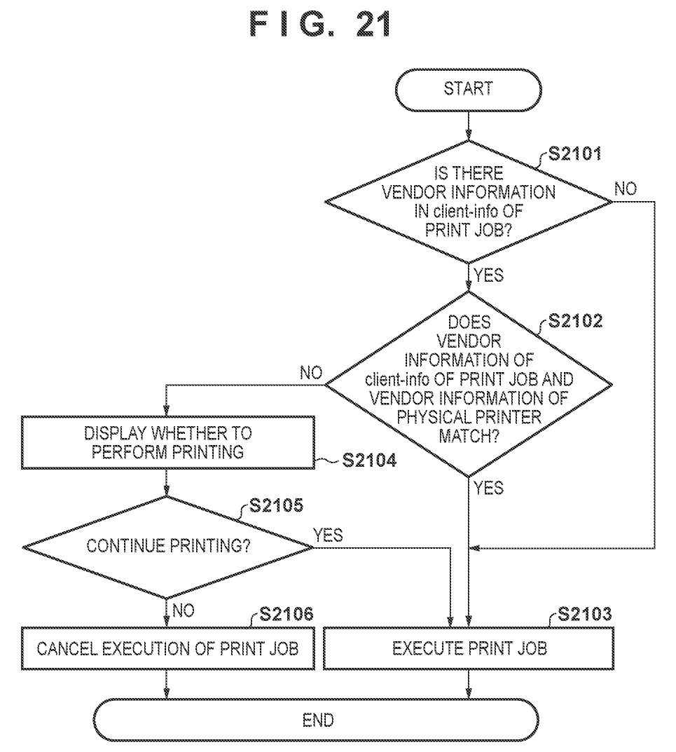

Next, the processing by the printing apparatuses 120 and 121 to execute a print job will be described with reference to FIG. 21. The processing described below is implemented by the CPU 501 of the printing apparatuses 120 and 121 reading out a program stored in the ROM 503 onto the RAM 502 and executing the program. The printing apparatuses 120 and 121 are referred to as the physical printer 1503 in the following description.

The flow of FIG. 21 starts when the physical printer 1503 receives a print job from the print server. In S2101, the CP control unit 707 of the physical printer 1503 determines whether or not, in the print job, the vendor information is included in the client-info. In a case where the vendor information is not included in the client-info (in the case of no), since extended printing via the PSA 413 has not been set, printing via the print settings set by the user can be performed regardless of the vendor of the physical printer. Thus, in S2101, in the case of no, the processing advances to S2103, and the print processing unit 704 of the physical printer 1503 executes the print job.

On the other hand, in S2101, in a case where the CP control unit 707 of the physical printer 1503 determines that the client-info is included in the print job (in the case of yes), the processing advances to S2102. In a case where the vendor information is included in the client-info added to the print job, since extended printing via the PSA 413 has been set, in some cases, an extended print setting with a printer other than a physical printer of the same vendor as the PSA 413 may be disabled. With the configuration of FIG. 15, the vendor of the physical printers 1503a and 1503b is the same as the vendor of the PSA 413, but the vendor of the physical printer 1503c is different from the vendor of the PSA 413.

In S2102, the CP control unit 707 of the physical printer 1503 determines whether the vendor information of the client-info of the print job and the vendor information of the physical printer 1503 itself match. In a case where the vendor information of the client-info of the print job and the vendor information of the physical printer 1503 match in S2102 (yes), the processing advances to S2103, and the print processing unit 704 of the physical printer executes the print job. With the configuration of FIG. 15, since the vendor information of the physical printers 1503a and 1503b is AAA, this matches with the vendor information AAA included in the client information.

In a case where the vendor information of the client-info of the print job and the vendor information of the physical printer 1503 are different in S2102 (no), the CP control unit 707 of the physical printer 1503 advances the processing to S2104. With the configuration of FIG. 15, since the vendor information of the physical printer 1503c is BBB, this is different from the vendor information AAA included in the client information.

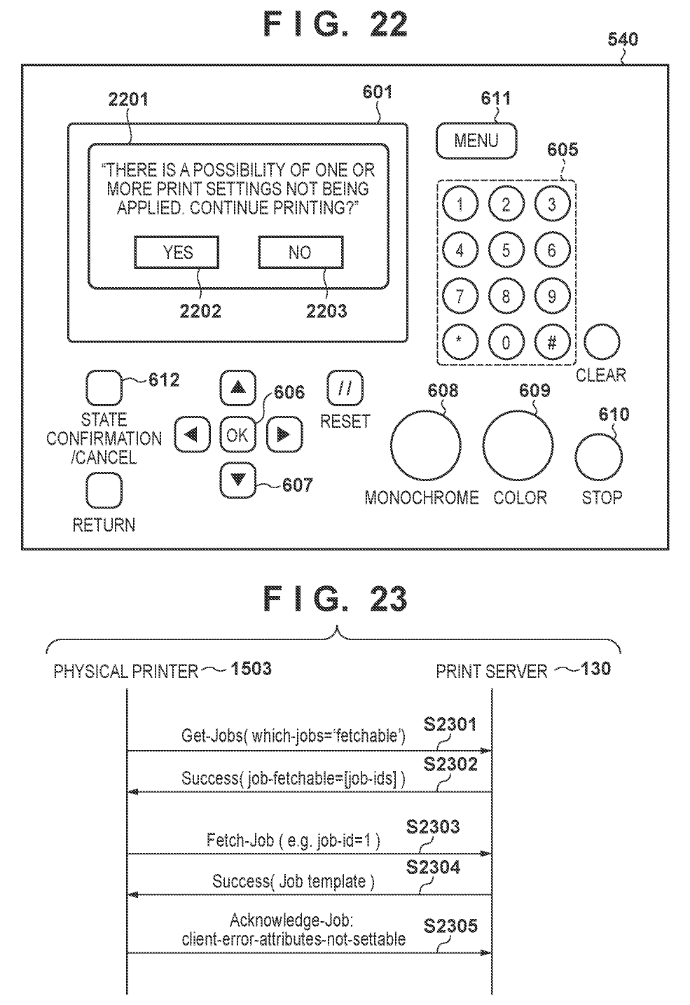

In S2104, a print output unit 702 of the physical printer 1503 displays, a display screen 2201 of FIG. 22 saying “There is a possibility of one or more print settings not being applied. Continue printing?” is displayed on the display panel 601 of the operation unit 540 using the operation unit I/F 507. The display screen 2201 of FIG. 22 displays a “Yes” button 2202 and a “No’ button 2203 for the user to select whether to continue printing or not. In S2105, in a case where the operation unit I/F 507 determines that the user has selected the “Yes” button 2202 (in the case of yes), the CP control unit 707 advances the processing to S2103. In S2103, the CP control unit 707 performs the sequence of S2005 of FIG. 20 onward, and the print processing unit 704 executes the print job. In this case, the extended print setting of the PSA 413 may be disabled in some cases.

On the other hand, in S2105, in a case where the display operation unit I/F 507 determines that the user has selected the “No” button 2203 of the display screen 2201 (in the case of no), the CP control unit 707 advances the processing to S2106 and executes processing to cancel the printing. In S2106, as illustrated in S2305 of FIG. 23, the CP control unit 707 transmits an error to the print server 130 via an Acknowledge-Job instead of notifying the print server 130 that a job has been received. As the content of the error, client-error-attributes-not-settable is transmitted. In S2305, when the CP control unit 707 transmits a client-error-attributes-not-settable error, the printing processing of the physical printer 1503 is cancelled. As the error message, an error message other than client-error-attributes-not-settable may be used.

The display screen 2201 of FIG. 22 displays whether to continue printing, but a message saying “The print settings cannot be applied to this printing apparatus. Please print with another printing apparatus.” may be displayed and the printing may be cancelled. Also, a message saying “One or more print settings have been disabled” may be displayed and the printing may be continued.

Next, the flow of the print server 130 of FIG. 19 is returned to. In S1904, the print control unit 302 of the print server 130 determines whether an error message has been received from the physical printer 1503. Reception of an error message is determined by whether a client-error-attributes-not-settable error has been received from the physical printer 1503 via an Acknowledge-Job. In S1904, when the print control unit 302 receives a client-error-attributes-not-settable error from the physical printer 1503 (in the case of yes), the processing advances to S1905. In S1905, the print control unit 302 of the print server 130 executes processing to return the print job of the individual logical printer 1502 to the comprehensive logical printer 1501.

In S1904, the reception of a client-error-attributes-not-settable error is determined, but the error content is not limited thereto. In the physical printer 1503, even in the case of a different error, the print job may be returned to the comprehensive logical printer 1501 from the individual logical printers 1502a to 1502c. Also, the processing to return the print job of the individual logical printer 1502 to the comprehensive logical printer 1501 may be executed by a user operation.

In S1904, in a case where the print control unit 302 has not received a print error from the physical printer 1503 (in the case of no), in other words, in a case where the print job reception of S2005 of FIG. 20 has been received, the print control unit 302 performs the printing sequence. The print control unit 302 of the print server 130 transmits the print job to the physical printer 1503 according to the sequence of S2006 onward of FIG. 20.

According to the present embodiment example, in a case where the print job with an extended print setting is printed with a physical printer by a user, the user can know of the possibility that the extended print setting may not be applied. The user can select whether to perform printing ignoring the extended print setting or to cancel printing and perform printing with a different physical printer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-159418, filed September 13, 2024 which is hereby incorporated by reference herein in its entirety.

What is claimed is:

1. A print server comprising:
one or more memory devices that store a set of instructions; and
one or more processors that execute the set of instructions to:
manage a logical printer associated with a printing apparatus and a comprehensive logical printer associated with the logical printer,
receive a print job with vendor information added from an information processing apparatus and store the print job in a print queue of the comprehensive logical printer,
receive an instruction to move the print job stored in the print queue to the printing apparatus, and
in a case where the instruction is received, move the print job to a logical printer associated with the printing apparatus, and when there is an error response for reception of the print job from the printing apparatus, move the print job to the comprehensive logical printer.

2. The print server according to claim 1, wherein
The error response for reception of the print job corresponds to receiving a client-error-attributes-not-settable via an Internet Printing Protocol (IPP) Acknowledge-Job.

3. The print server according to claim 1, wherein
the vendor information is included in client information indicating the information processing apparatus.

4. The print server according to claim 3, wherein
the client information is client-info of Internet Printing Protocol (IPP).

5. The print server according to claim 1, wherein
the vendor information is added in a case where an extended print setting is included in a print setting of the print job.

6. A printer comprising:
one or more memory devices that store a set of instructions; and
one or more processors that execute the set of instructions to:
receive a print job from a print server,
obtain vendor information added to the print job, and
execute a print job in a case where the vendor information added to the print job and vendor information of a printing apparatus match.

7. The printer according to claim 6, wherein
the one or more processors execute instructions in the one or more memory devices to:
perform a display for whether or not to continue printing in a case where the vendor information added to the print job and the vendor information of the printing apparatus do not match.

8. The printer according to claim 7, wherein
the one or more processors execute instructions in the one or more memory devices to:
perform a display in a selectable manner for whether or not to continue printing, in a case where the vendor information added to the print job and the vendor information of the printing apparatus do not match.

9. The printer according to claim 6, wherein
the one or more processors execute instructions in the one or more memory devices to:
perform a display indicating that one or more print settings will be disabled in a case where the vendor information added to the print job and the vendor information of the printing apparatus do not match.

10. The printer according to claim 6, wherein
the one or more processors execute instructions in the one or more memory devices to:
perform a display prompting for printing to be performed with another printing apparatus in a case where the vendor information added to the print job and the vendor information of the printing apparatus do not match.

11. The printer according to claim 8, wherein
the one or more processors execute instructions in the one or more memory devices to:
in a case where it is selected to not continue the printing, transmit an error response for reception of the print job to the print server.

12. The printer according to claim 11, wherein
the error response for reception of the print job corresponds to transmitting a client-error-attributes-not-settable via an Internet Printing Protocol (IPP) Acknowledge-Job.

13. The printer according to claim 6, wherein
the vendor information added to the print job is included in client information indicating the information processing apparatus to which the print job was submitted.

14. The printer according to claim 13, wherein
the client information is client-info of Internet Printing Protocol (IPP).

15. A control method for a print server, comprising:
managing a logical printer associated with a printing apparatus and a comprehensive logical printer associated with the logical printer;
receiving a print job with vendor information added from an information processing apparatus and storing the print job in a print queue of the comprehensive logical printer;
receiving an instruction to move the print job stored in the print queue to the printing apparatus;
moving the print job to a logical printer associated with the printing apparatus in a case where the instruction is received; and
when there is an error response for reception of the print job from the printing apparatus, moving the print job to the comprehensive logical printer.

16. A non-transitory computer-readable storage medium storing a program that causes a print server to execute a control method when executed by a computer of the print server, the method comprising:
managing a logical printer associated with a printing apparatus and a comprehensive logical printer associated with the logical printer;
receiving a print job with vendor information added from an information processing apparatus and storing the print job in a print queue of the comprehensive logical printer;
receiving an instruction to move the print job stored in the print queue to the printing apparatus;
moving the print job to a logical printer associated with the printing apparatus in a case where the instruction is received; and
when there is an error response for reception of the print job from the printing apparatus, moving the print job to the comprehensive logical printer.

17. A control method for a printer, comprising:
receiving a print job from a print server;
obtaining vendor information added to the print job; and
executing a print job in a case where the vendor information added to the print job and vendor information of a printing apparatus match.

18. A non-transitory computer-readable storage medium storing a program that causes a printer to execute a control method when executed by a computer of the printer, the method comprising:
receiving a print job from a print server;
obtaining vendor information added to the print job; and
executing a print job in a case where the vendor information added to the print job and vendor information of a printing apparatus match.
